(19) United States
(12) Patent Application Publication
(10) Pub. No.: US 2018/0048565 A1
(43) Pub. Date: Feb. 15, 2018

(54) CONTROL APPARATUS, COMMUNICATION SYSTEM, NETWORK FUNCTION PROVISION APPARATUS, COMMUNICATION APPARATUS, COMMUNICATION METHOD, AND PROGRAM

(71) Applicant: NEC Corporation, Tokyo (JP)

(72) Inventor: Yoshiyuki YAMADA, Tokyo (JP)

(73) Assignee: NEC Corporation, Tokyo (JP)

(21) Appl. No.: 15/554,833

(22) PCT Filed: Mar. 17, 2016
(86) PCT No.: PCT/JP2016/058449

§ 371 Date: Aug. 31, 2017

(30) Foreign Application Priority Data
Mar. 19, 2015 (JP) 2015-056368
Mar. 19, 2015 (JP) 2015-056369

(51) Int. Cl. H04L 12/741; H04L 12/815

(52) U.S. Cl. CPC H04L 45/74; H04L 47/22; H04L 12/66

(57) ABSTRACT

A function of switching a path such as traffic offload and application of a predetermined network function(s) are both enabled. A control apparatus includes: first means for providing at least one of a plurality of network functions of a first network; second means for determining, based on an attribute(s) of a received packet, whether to forward the packet to a path in which the first means operates or to the first network; and third means for giving an instruction about a forwarding destination of the received packet to a predetermined packet forwarding apparatus in accordance with the determination.

### CROSS REFERENCE TO RELATED APPLICATIONS

This application is a National Stage of International Application No. PCT/JP2016/058449, filed Mar. 17, 2016, claiming priorities based on Japanese Patent Application Nos. 2015-056368 and 2015-056369, filed Mar. 19, 2015 respectively, the contents of all of which are incorporated herein by reference in their entirety.

### FIELD

The present invention relates to a control apparatus, a communication system, a network function provision apparatus, a communication apparatus, a communication method, and a program. In particular, it relates to provision of a network function(s) for the above elements.

### BACKGROUND

In recent years, aside from network management functions provided by operation systems, functions provided to users on the network side have often been called “network functions.” For example, in a mobile core network that constitutes a mobile communication network, various network functions are realized by network apparatuses such as an MME (Mobility Management Entity) and an S-GW (Serving Gateway)/P-GW (Packet data network Gateway).

The recent increase in communication network traffic has required expansion in network capacity. In order to expand a network capacity, a new network apparatus(es) having a network function(s) needs to be arranged. This will incur significant costs on network operators, such as for purchasing the network apparatus(es) and preparing installation space therefor.

In view of such circumstances, a traffic offload technique as defined in Non-Patent Literature (NPL) 1 has been considered. In this technique, terminals and apparatuses directly communicate with the Internet by bypassing a dedicated apparatus having a network function(s). In this way, network expansion is achieved at low cost.

Patent Literature (PTL) 1 discloses a communication system that starts traffic offload upon reception of a trigger signal instructing packet offload. PTL 2 discloses a small-sized radio base station that notifies a charging apparatus of a communication amount.
PTL 1: Japanese Patent Kokai Publication No. JP2013-046344A
PTL 2: Japanese Patent Kokai Publication No. JP2013-258585A
NPL 1: 3GPP TR 23.829, V10.0.1 (October 2011) “3rd Generation Partnership Project; Technical Specification Group Services and System Aspects; Local IP Access and Selected IP Traffic Offload (LIPA-SIPTO)”

### SUMMARY

The following analysis has been made by the present inventor. When traffic is offloaded, there are cases where a network function(s) is needed in the offloaded traffic, depending on the situation. For example, when a law enforcement agency (LEA) performs monitoring on offloaded traffic, a lawful interception (LI) function, which is a network function, is needed.

However, when traffic is offloaded, network functions cannot be used. Namely, there is a problem that a necessary function(s) cannot be applied to the offloaded traffic.

It is an object of the present invention to contribute to providing a network that enables both a function of switching a path such as traffic offload and application of a predetermined network function(s).

According to a first aspect, there is provided a control apparatus including a first unit configured to provide at least one of a plurality of network functions of a first network. This control apparatus also includes a second unit configured to determine, based on an attribute(s) of a received packet, whether to forward the packet to a path in which the first unit operates or to the first network. In addition, this control apparatus includes a third unit configured to give an instruction about a forwarding destination of the received packet to a predetermined packet forwarding apparatus in accordance with the determination.

According to a second aspect, there is provided a communication system, including: a first unit configured to provide at least one of a plurality of network functions of a first network; a second unit configured to determine, based on an attribute(s) of a received packet, whether to forward the packet to a path in which the first unit operates or to the first network; and a third unit configured to give an instruction about a forwarding destination of the received packet to a predetermined packet forwarding apparatus in accordance with the determination.

According to a third aspect, there is provided a network function provision apparatus, connected to the communication system and providing, as the first unit, a network function(s) by using a virtual machine(s).

According to a fourth aspect, there is provided a communication method, including: determining, based on an attribute(s) of a received packet, whether to forward the packet to a path in which a first apparatus providing at least one of a plurality of network functions of a first network or to the first network; and giving an instruction about a forwarding destination of the received packet to a predetermined packet forwarding apparatus in accordance with the determination. The present method is associated with a certain machine called a control apparatus that controls forwarding paths.

According to a fifth aspect, there is provided a program, causing a computer to perform processing for: determining, based on an attribute(s) of a received packet, whether to forward the packet to a path in which a first apparatus providing at least one of a plurality of network functions of a first network or to the first network; and giving an instruction about a forwarding destination of the received packet to a predetermined packet forwarding apparatus in accordance with the determination. This program can be recorded in a computer-readable (non-transient) recording medium. Namely, the present invention can be embodied as a computer program produce.

An individual element of the above control apparatus, communication system, network function provision apparatus, communication method, and program contributes to solving the above problem.

The meritorious effects of the present invention are summarized as follows.
The present invention can contribute to providing a network that enables both a forwarding path switching function and application of a predetermined network function(s). Namely, the present invention transforms an individual control apparatus described in Background into a control apparatus that enables both a forwarding path switching function and application of a predetermined network function(s).

### BRIEF DESCRIPTION OF THE DRAWINGS

FIG. 1 illustrates a configuration example of a communication system according to a first example embodiment.

FIG. 2 illustrates a configuration example of an offload apparatus 20 according to the first example embodiment.

FIG. 3 illustrates an operation example according to the first example embodiment.

FIG. 4 illustrates a configuration example of a control apparatus 70 according to a second example embodiment.

FIG. 5 illustrates a configuration example of a control unit 720 according to the second example embodiment.

FIG. 6 illustrates an example of a table held in a storage unit 730 according to the second example embodiment.

FIG. 7 illustrates an example of a table held in the storage unit 730 according to the second example embodiment.

FIG. 8 illustrates an operation example according to the second example embodiment.

FIG. 9 illustrates a configuration example of a server 80 used in a third example embodiment.

FIG. 10 illustrates an operation example according to the third example embodiment.

FIG. 11 illustrates a configuration example of a server 80A used in a fourth example embodiment.

FIG. 12 illustrates a configuration example of a variation according to the fourth example embodiment.

FIG. 13 illustrates a configuration example of a server 80B used in a fifth example embodiment.

FIG. 14 illustrates a configuration example of a control unit 840 of the server 80B according to the fifth example embodiment.

FIG. 15 illustrates an operation example according to the fifth example embodiment.

FIG. 16 illustrates another operation example according to the fifth example embodiment.

FIG. 17 illustrates a specific operation according to the fifth example embodiment.

FIG. 18 illustrates a configuration example of a packet classification apparatus 90 used in a sixth example embodiment.

FIG. 19 illustrates a specific operation according to the sixth example embodiment.

FIG. 20 illustrates a configuration example of a variation according to the sixth example embodiment.

FIG. 21 illustrates a configuration example of an operation management apparatus 110 used in a seventh example embodiment.

FIG. 22 illustrates a configuration example of a communication system according to an eighth example embodiment.

FIG. 23 illustrates a configuration example of an OFC 7000 according to the eighth example embodiment.

FIG. 24 illustrates an example of a UE information management table used in the eighth example embodiment.

FIG. 25 illustrates a configuration example of a communication system according to a ninth example embodiment.

FIG. 26 illustrates a configuration example of a server 12000 according to the ninth example embodiment.

FIG. 27 illustrates a configuration example of a server 12000A according to the ninth example embodiment.

FIG. 28 illustrates a configuration example of an OFC 7000A according to the ninth example embodiment.

FIG. 29 illustrates a configuration example of a server 12000B according to the ninth example embodiment.

FIG. 30 illustrates a configuration example of an OFC 7000B according to the ninth example embodiment.

FIG. 31 illustrates a configuration example of a communication system according to a tenth example embodiment.

FIG. 32 illustrates a configuration example of a communication system according to an eleventh example embodiment.

FIG. 33 illustrates a configuration example of a communication system according to a twelfth example embodiment.

### MODES

Hereinafter, example embodiments of the present disclosure will be described. The following example embodiments will be described merely as examples, and the present disclosure is not limited thereto.

### First Example Embodiment

In a first example embodiment of the present disclosure, an offload apparatus can refer to identification information about an attribute(s) of a packet and select a forwarding destination of the packet based on the necessity of offload and the necessity of application of a predetermined network function(s). Thus, the first example embodiment enables application of a predetermined network function(s) while performing traffic offload.

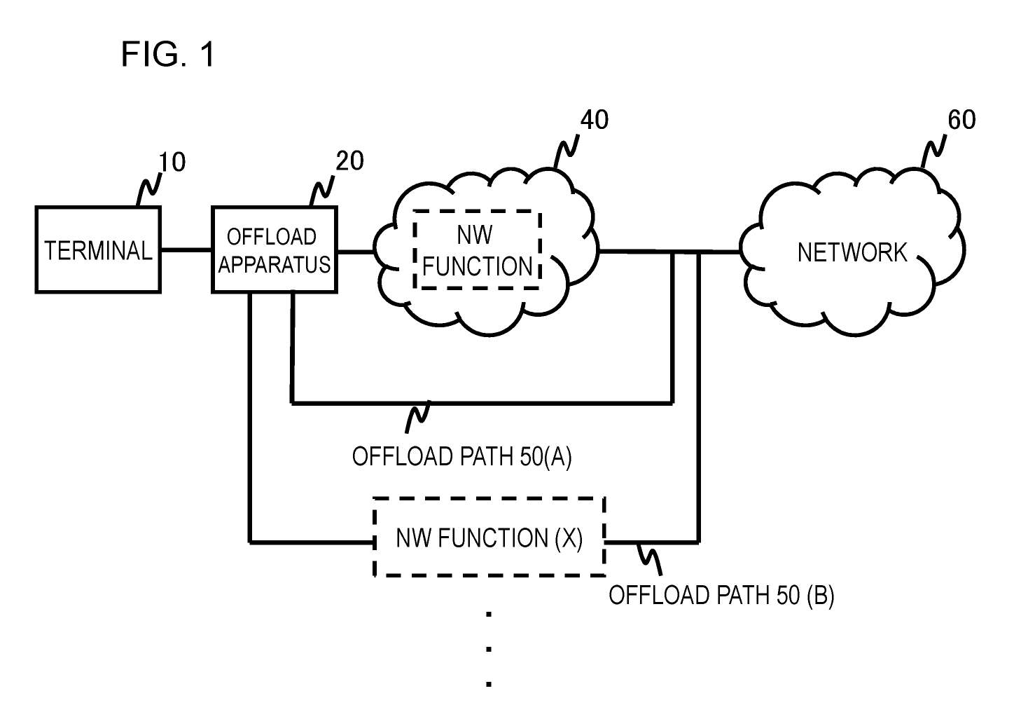

FIG. 1 illustrates a configuration example of a communication system according to the first example embodiment. In FIG. 1, a terminal 10 connects to an offload apparatus 20 and accesses a network 60 via a network 40 or an offload path 50.

The offload apparatus 20 can forward a packet received from the terminal 10 to the network 40 or the offload path 50 based on an attribute(s) of the packet. The network 40 corresponds to the above first network. For example, the network 40 includes a network node(s) having a network (NW) function(s) such as an S-GW and a P-GW. An individual network node included in the network 40 performs processing, based on its own network function, on the packet received by the network 40. In this way, a communication service provided by the communication system is realized.

The offload path 50 is a path that bypasses the network 40 and connects to the network 60. A single offload path 50 or a plurality of offload paths 50 bypassing the network 40 may be used. In addition, an offload path 50 may send an offload packet to the network 60 without change or may apply a part of the network functions included in the network 40 to an offload packet. A network node(s) such as a gateway, a router, and a switch may additionally be arranged where the network 40, the offload path 50, and the network 60 are connected to each other.

In the example in FIG. 1, both an offload path 50(A) and an offload path 50(B) bypass the network 40 and connect to the network 60. The offload path 50(A) sends an offload packet to the network 60 without change. The offload path 50(B) applies a network function (X) to an offload packet. The network function (X) is a part of the network functions applicable in the network 40.

As needed, a plurality of offload paths such as offload paths 50(C) and 50(D) may additionally be arranged, and different network functions may be applied to packets that pass through the respective offload paths. In this case, based on the attribute(s) of a packet received from the terminal 10, the offload apparatus 20 forwards the packet to an appropriate path selected from the network 40 and the plurality of offload paths (A, B, . . . ).

For example, the communication system illustrated in FIG. 1 includes the following network functions.

### RADIUS (Remote Authorization Dial In User Service):

Function of authenticating users accessing a network (authentication function);
Function of authorizing authenticated users to access a network (authorization function); and
Function of monitoring access for accounting management (accounting function).

### P-GW:

Function of processing packets (User-Plane function);
Function of managing charging statuses based on respective communications (PCEF: Policy and Charging Enforcement Function);
Function of controlling policies such as QoS (Quality of Service) (PCRF: Policy and Charging Rule Function); and
LI function.

### S-GW:

Function of processing packets (User-Plane function);
Function of processing control signaling (C-Plane function) MME (Mobility Management Entity);
Function of processing control signaling (C-Plane function): for example, setting and releasing communication sessions, controlling handovers, etc.; and
Function of managing information about subscribers of a communication system in cooperation with an HSS (Home Subscriber Server).
   Base station:
Function of performing digital baseband signal processing; and
Function of performing analog radio frequency (RF) signal processing.

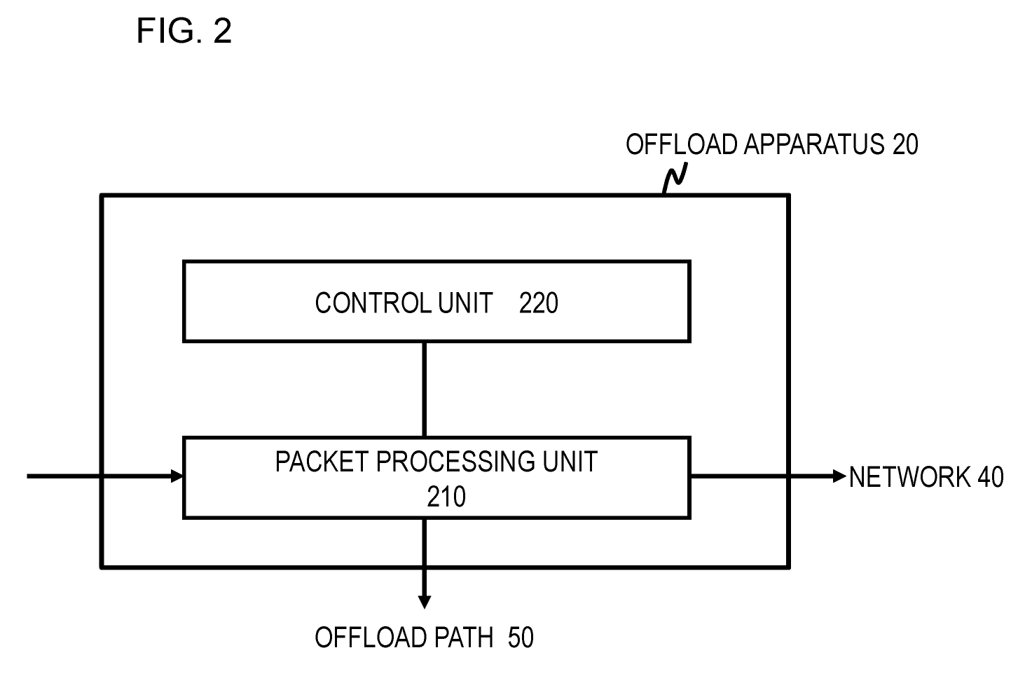

FIG. 2 illustrates a configuration example of the offload apparatus 20 according to the first example embodiment. In FIG. 2, the offload apparatus 20 includes a packet processing unit 210 and a control unit 220. The control unit 220 controls the forwarding path of a received packet. For example, the control unit 220 determines whether a received packet is an offload target packet and whether a network function(s) needs to be applied to the received packet and selects a forwarding path according to the determination results. The packet processing unit 210 forwards the received packet in accordance with the control processing performed by the control unit 220. For example, the packet processing unit 210 forwards the received packet to the path selected by the control unit 220 from the network 40 and the offload path(s) 50.

For example, the control unit 220 selects the network 40 as the forwarding destination of a packet that is not an offload target. In addition, for example, the control unit 220 selects the offload path 50(A) as the forwarding destination of a packet to which none of the network functions need to be applied. In addition, for example, the control unit 220 selects the offload path 50(B) as the forwarding destination of a packet that is an offload target and to which the network function (X) needs to be applied.

The control unit 220 can simply use information stored in the packet header of a packet as the packet attribute(s) to determine whether a network function(s) needs to be applied to the packet. However, other information may alternatively be used. For example, information about a communication terminal that transmits and receives a packet, information about a user who uses the communication terminal, information about a service provided by the network, or information for identifying the network may be used. Alternatively, for example, time and place (a location in the network) at which a packet has been received may be used. Of course, a combination of a plurality of these attributes may be used to determine the necessity of application of a network function(s).

For example, the control unit 220 may select a forwarding path of a packet in view of the necessity of an offload function and the necessity of a plurality of network functions. In this case, the packet processing unit 210 forwards the packet to one of the network 40 and the offload paths 50 (A, B, . . . ) based on the necessity of offload and the function(s) to be applied.

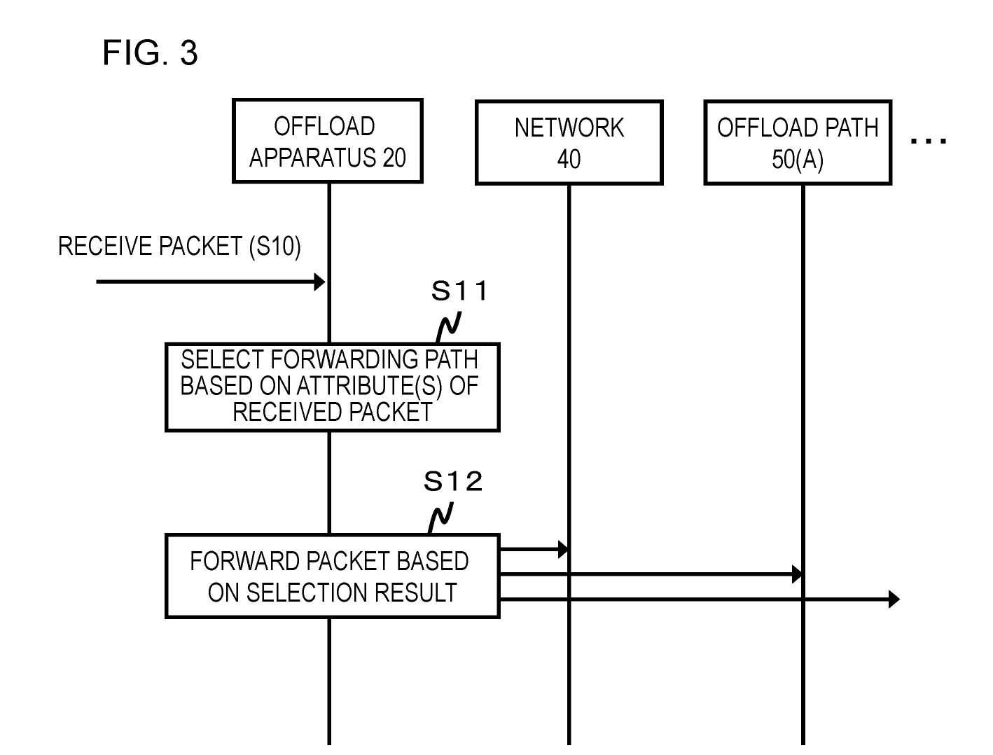

FIG. 3 illustrates an operation example according to the first example embodiment. First, the offload apparatus 20 receives a packet from the terminal 10 (S10). The offload apparatus 20 selects the forwarding path of the received packet based on an attribute(s) of the received packet (S11). For example, the attribute(s) of the received packet may be related to the necessity of offload and the necessity of application of a predetermined function(s).

Based on the selection result, the offload apparatus 20 forwards the packet to one of the network 40 and the offload paths 50 (S12). Based on the network function(s) to be applied, the control unit 220 may select a predetermined offload path from the plurality of offload paths as the forwarding destination of the received packet.

In the first example embodiment, the offload apparatus 20 may select a forwarding path by referring to its table(s) or to an external database. Alternatively, the offload apparatus 20 may select a forwarding path in accordance with externally provided control information.

In the first example embodiment, the offload apparatus 20 may be arranged as an independent apparatus in the network or may be included in a base station apparatus or the like.

### Second Example Embodiment

According to a second example embodiment of the present disclosure, a control apparatus 70 controls the offload apparatus 20. Since the control apparatus 70 can control the offload apparatus 20 in a centralized manner, the offloading and the network function(s) can be efficiently controlled. The technique to be described in the second example embodiment is applicable to the techniques described in the first example embodiment and any of the following example embodiments.

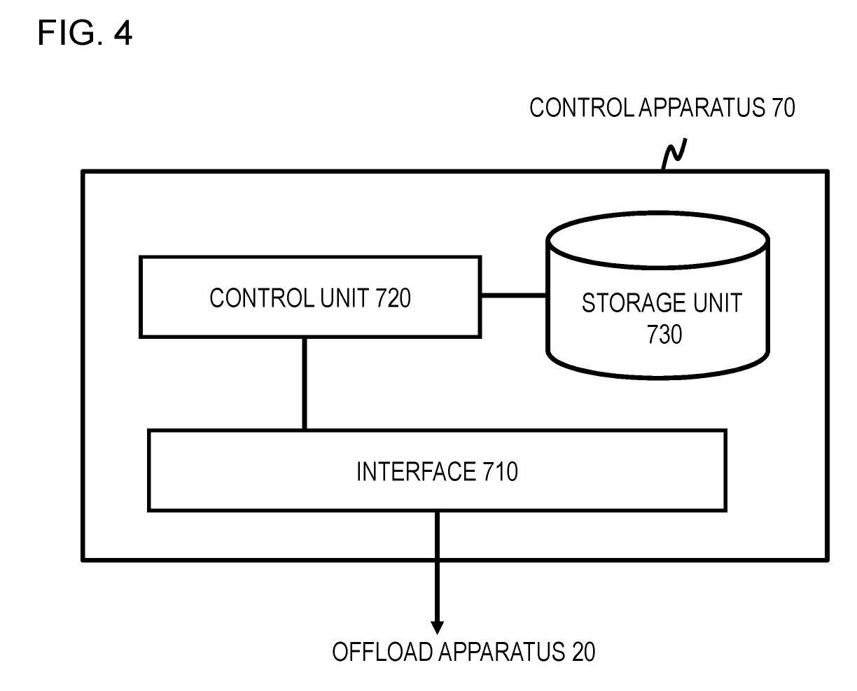

FIG. 4 illustrates a configuration example of the control apparatus 70 according to the second example embodiment. In FIG. 4, the control apparatus 70 includes an interface 710, a control unit 720 and a storage unit 730. The control apparatus 70 can communicate with the offload apparatus 20 via the interface 710 (corresponding to the second and third means).

The control unit 720 can instruct the control unit 220 of the offload apparatus 20 to select the forwarding path of a received packet as in the first example embodiment. For example, the control unit 720 instructs the control unit 220 to determine whether a received packet is an offload target packet and whether a network function(s) needs to be applied to the received packet and to select a forwarding path based on the determination results.

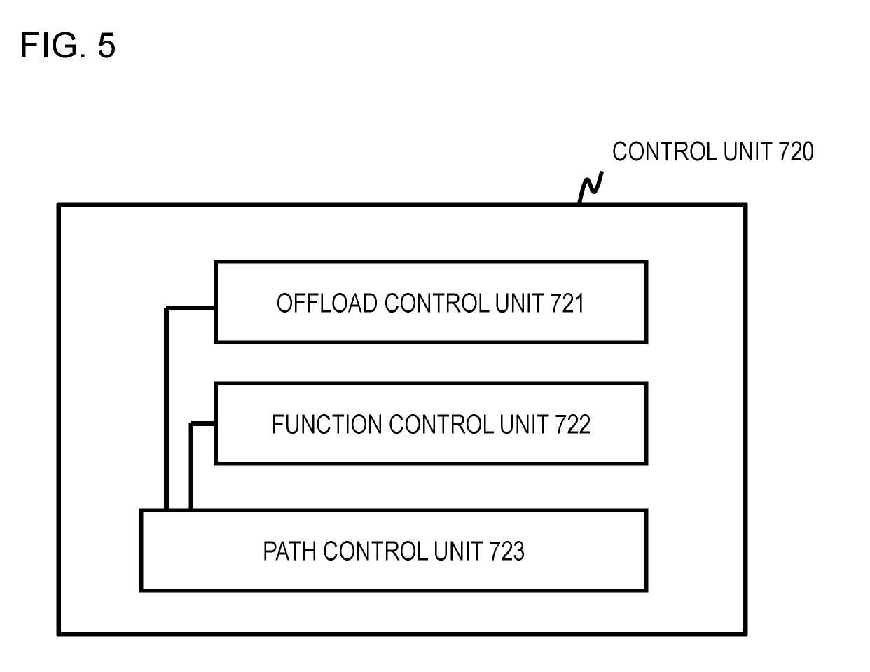

FIG. 5 is a configuration example of the control unit 720 according to the second example embodiment. In FIG. 5, the control unit 720 includes an offload control unit 721, a function control unit 722, and a path control unit 723. The offload control unit 721 controls packet offloading. More specifically, the offload control unit 721 determines whether a predetermined packet is an offload target packet. The function control unit 722 controls a network function(s) to be applied to a packet. For example, the function control unit 722 determines whether a predetermined packet is a target packet to which a predetermined network function needs to be applied. In addition, the function control unit 722 may determine whether a plurality of network functions need to be applied to the target packet.

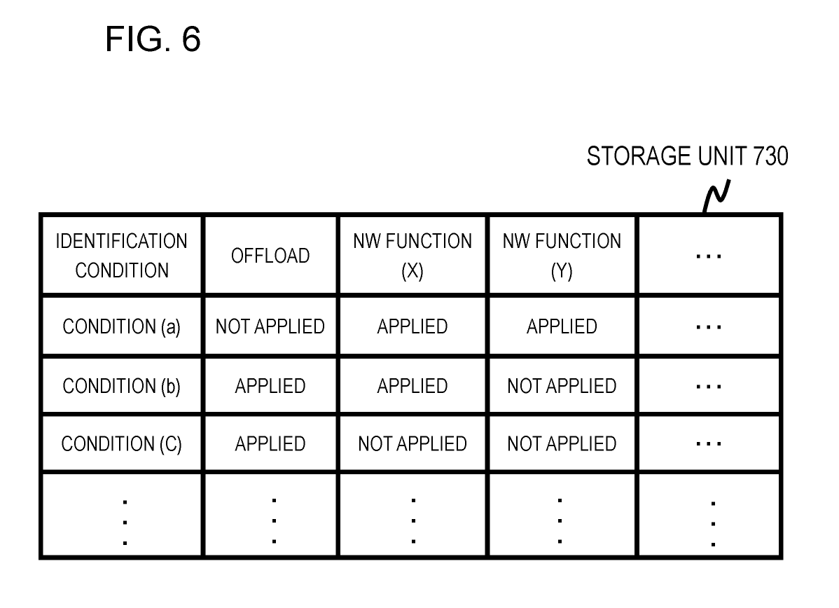

The offload control unit 721 and the function control unit 722 can refer to a table(s) held in the storage unit 730, for example. FIG. 6 illustrates an example of a table held in the storage unit 730 according to the second example embodiment. The table in the storage unit 730 in FIG. 6 indicates the necessity of offload and the necessity of application of individual network functions per identification condition.

For example, an identification condition is information about an attribute(s) of a packet received by the offload apparatus. Examples of the identification condition include information about a communication terminal that transmits and receives a packet, information about a user who uses the communication terminal, information about a service provided by the network, and information for identifying the network. In addition, the identification condition may include information about a priority level such as a QCI (QoS Class Indicator). In FIG. 6, a packet that matches a condition (a) is not an offload target packet but is a target to which both NW functions (X) and (Y) are applied. A packet that matches a condition (b) is an offload target packet and a NW function (X) target, but not a NW function (Y) target. In addition, in FIG. 6, while an individual entry under a column “offload” represents “APPLIED” or “NOT APPLIED,” an individual entry may represent whether the offload is being performed or not.

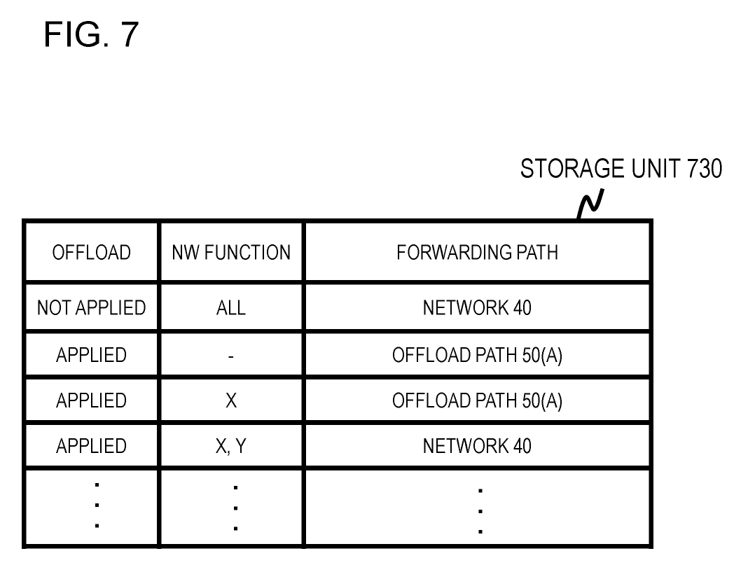

The path control unit 723 determines a forwarding path from the offload apparatus 20 based on the determination results obtained by the offload control unit 721 and the function control unit 722. FIG. 7 illustrates an example of a table held in the storage unit 730 according to the second example embodiment. The table in FIG. 7 illustrates forwarding paths determined depending on the necessity of offload and a network function(s) to be applied. For example, the path control unit 723 refers to the table in FIG. 7 and determines a forwarding path that corresponds to the determination results obtained by the offload control unit 721 and the function control unit 722. The path control unit 723 instructs the control unit 220 to select the determined forwarding path.

In FIG. 7, when offload is not applied, regardless of the necessity of application of a network function(s), the control unit 220 selects the network 40 as the forwarding path. When offload is applied and none of the network functions need to be applied, the control unit 220 selects the offload path 50(A) as the forwarding path.

In the examples in FIGS. 6 and 7, since a packet that matches the identification condition (a) does not need to be offloaded, the packet is forwarded to the network 40. Since a packet that matches the identification condition (b) needs to be offloaded, and a network function (X) needs to be applied, the packet is forwarded to the offload path 50(B).

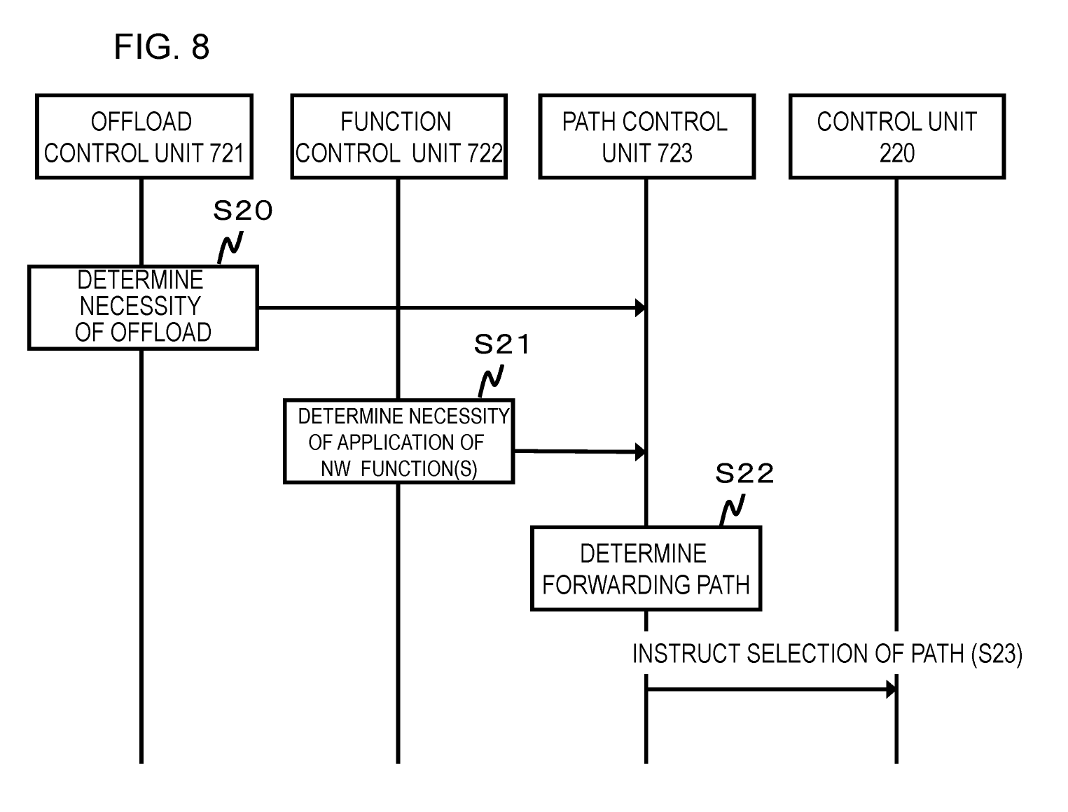

FIG. 8 illustrates an operation example according to the second example embodiment. First, the offload control unit 721 determines the necessity of offload (S20). For example, the offload control unit 721 refers to a table as illustrated in FIG. 6 and determines whether a target packet that matches any of the predetermined identification conditions is an offload target.

Next, the function control unit 722 determines the necessity of application of a network function(s) (S21). For example, the function control unit 722 refers to a table as illustrated in FIG. 6 and determines whether any of the functions needs to be applied to the target packet that matches any of the predetermined identification conditions.

The path control unit 723 determines a forwarding path based on the determination results obtained by the offload control unit 721 and the function control unit 722 (S22). For example, the path control unit 723 refers to a table as illustrated in FIG. 7 and determines a forwarding path that corresponds to the determination results obtained by the offload control unit 721 and the function control unit 722. The path control unit 723 instructs the control unit 220 of the offload apparatus 20 to select the determined forwarding path (S23).

Alternatively, the offload apparatus 20 may include the above functions of the control apparatus 70 and may realize the above control processing. In addition, the above description has been made assuming that the offload control unit 721 and the function control unit 722 are independently arranged in the control apparatus 70 for convenience of description. However, the offload control unit 721 and the function control unit 722 may be integrated in a single unit. In this case, the determination of whether a packet that matches any of the predetermined identification conditions is an offload target and the determination of a function(s) to be applied to the packet are performed simultaneously.

As described above, according to the present example embodiment, since the offload apparatus 20 can be controlled in a centralized manner, an efficient operation can be achieved.

### Third Example Embodiment

Next, a third example embodiment will be described with reference to the drawings. In the third example embodiment, a server (a network function provision apparatus, which corresponds to the first means) that provides a NW function(s) is arranged in an offload path. The following description will be made with a focus on the difference between the first and third example embodiments, omitting description of common features therebetween.

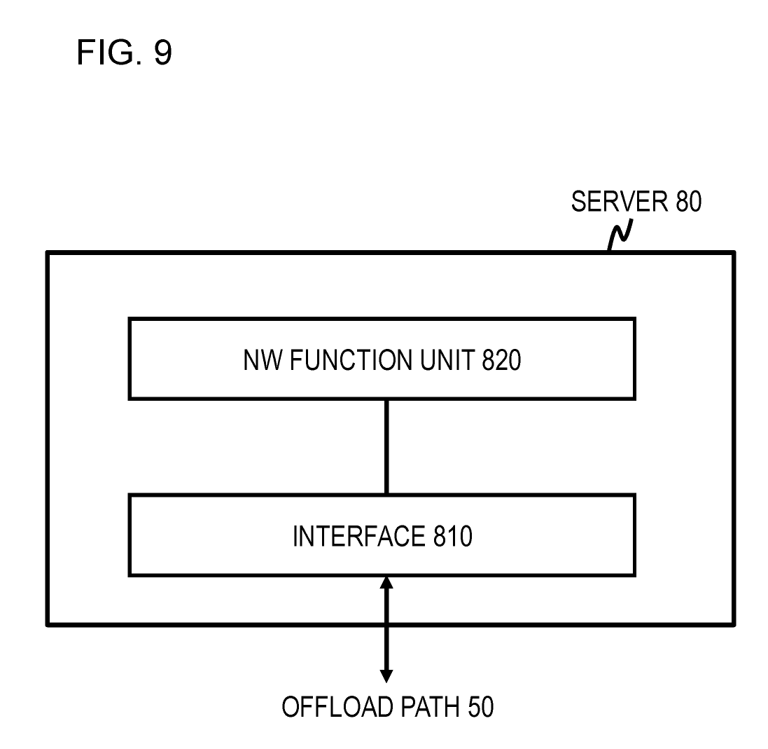

FIG. 9 illustrates a configuration example of a server 80 used in the third example embodiment. In FIG. 9, the server 80 includes an interface 810 and a NW function unit 820. The server 80 is arranged in the offload path 50(B) in FIG. 1 and provides a NW function (X). More specifically, the NW function unit 820 of the server 80 receives packets via the interface 810 and outputs packets to the offload path 50(B) via the interface 810.

For example, the NW function unit 820 is a virtual machine that realizes a corresponding NW function. The NW function unit 820 activates a virtual machine and causes the virtual machine to provide a desired NW function. In this way, a NW function(s) to be provided in the offload path can be added or modified.

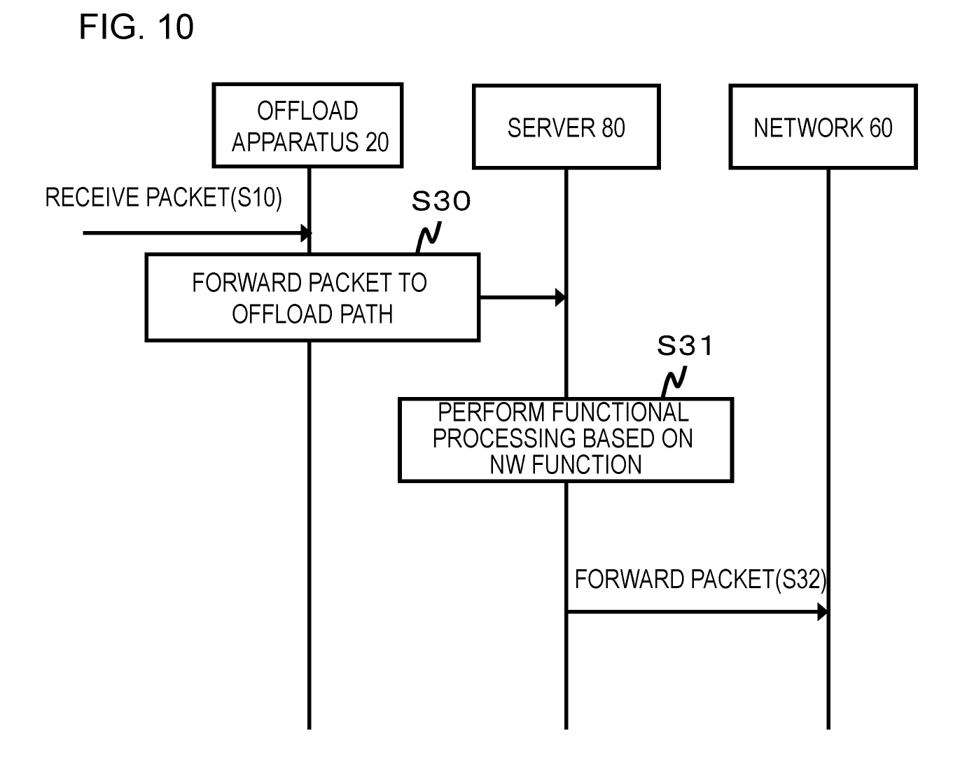

FIG. 10 illustrates an operation example according to the third example embodiment. First, as in the first example embodiment, the offload apparatus 20 receives a packet from the terminal 10 (S10). The offload apparatus 20 selects the forwarding path of the received packet based on an attribute(s) of the packet and forwards the selected packet to the forwarding path (S30). The following description will be made assuming that the application of offload and the NW function (X) has been determined and the packet has been forwarded to the offload path 50(B) in FIG. 1.

When the server 80 receives the packet, the server 80 causes the NW function unit 820 to perform processing that corresponds to the NW function (X) (S31). In step 31, the NW function unit 820 may modify a processing content based on the attribute(s) of the packet. When the processing has been performed, the server 80 transmits the packet to the network 60 along the offload path 50(B) in FIG. 1.

As described above, according to the present example embodiment, various NW functions can be provided by using a simple configuration. This is because the server 80 that can provide necessary NW functions by using virtual machines is arranged. In addition, according to the present example embodiment, NW functions can finely be provided by using a simple configuration. This is because the NW function unit 820 can modify a processing content based on an attribute(s) of a packet.

### Fourth Example Embodiment

Next, a fourth example embodiment in which the server according to the third example embodiment is modified will be described with reference to the drawings. The following description will be made with a focus on the difference between the third and fourth example embodiments, omitting description of common features therebetween.

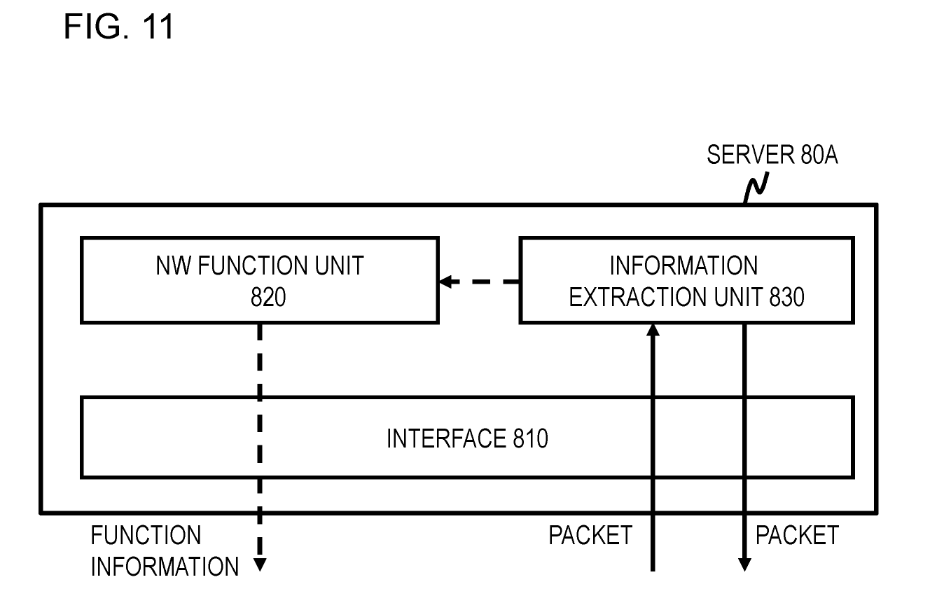

FIG. 11 illustrates a configuration example of a server 80A according to the fourth example embodiment. In FIG. 11, the server 80A includes an interface 810, an NW function unit 820, and an information extraction unit 830. The server 80A is arranged in the offload path 50(B) in FIG. 1 and provides the NW function (X). More specifically, the information extraction unit 830 of the server 80A receives a packet via the interface 810.

The information extraction unit 830 extracts necessary information from the received packet and transmits the information to the NW function unit 820. The packet received by the information extraction unit 830 is transmitted to the offload path 50(B) via the interface 810. The information extracted by the information extraction unit 830 from the packet is determined depending on the network function provided by the NW function unit 820. For example, when the NW function unit 820 provides a function such as packet counting or charging, the information extraction unit 830 transmits only the information needed for corresponding processing to the NW function unit 820. As another example, when the NW function unit 820 provides a function such as LI or traffic analysis, the information extraction unit 830 may duplicate a target packet itself and transmit the duplicated packet to the NW function unit 820.

As described above, the present example embodiment not only archives the advantageous effects produced by the third example embodiment but also enables the server 80A to perform processing that uses information or a packet extracted from a packet. This is because the information extraction unit 830 is arranged in the server 80A so that necessary information can be extracted.

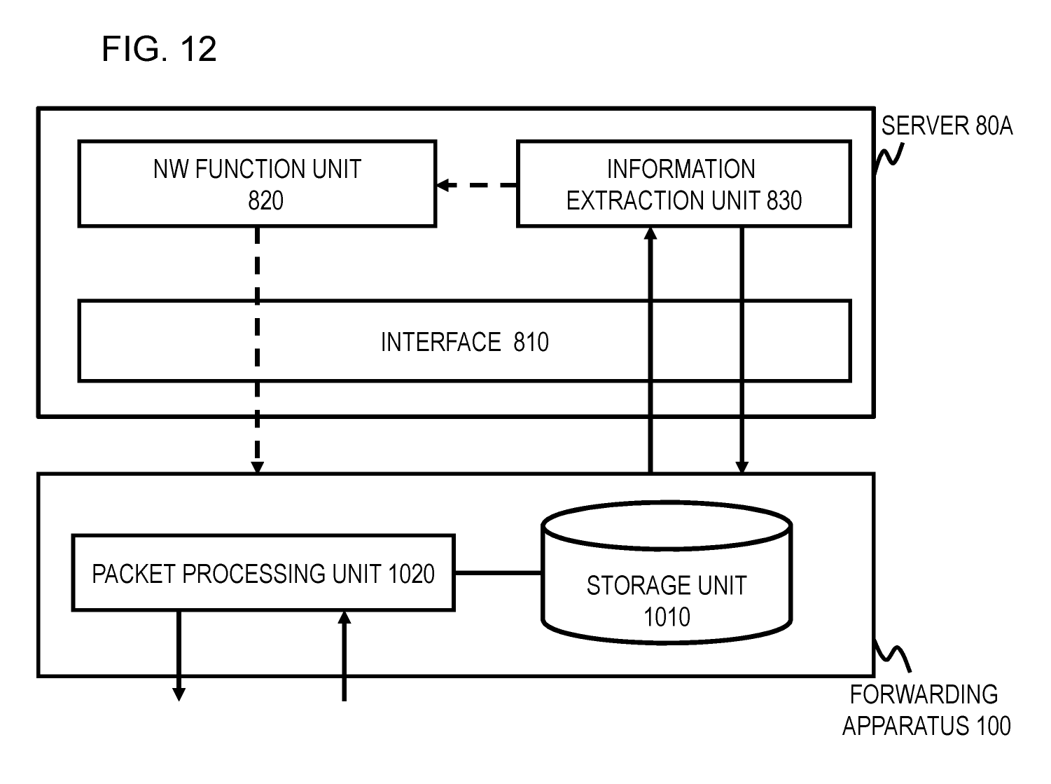

In addition, as illustrated in FIG. 12, the present example embodiment may have a different configuration in which a forwarding apparatus is included. In the example in FIG. 12, a forwarding apparatus 100 that selects packets that need to be transmitted to the server 80A is arranged.

The forwarding apparatus 100 includes a storage unit 1010 and a packet processing unit 1020. The storage unit 1010 holds conditions for determining packets that need to be transmitted to the server 80A and control information that defines processing for forwarding the packets to the server 80A. The forwarding apparatus 100 may be configured by using an OpenFlow switch or the like.

The packet processing unit 1020 refers to the control information held in the storage unit 1010, selects packets that need to be transmitted to the server 80A from received packets, and transmits the selected packets to the server 80A.

The load on the server 80A according to this variation is less than that on the server 80A in FIG. 11. This is because a mechanism is arranged upstream of the server 80A and this mechanism selects packets necessary for provision of a corresponding function by the NW function unit 820.

### Fifth Example Embodiment

Next, a fifth example embodiment in which the server according to the third example embodiment is modified will be described with reference to the drawings. The following description will be made with a focus on the difference between the third and fifth example embodiments, omitting description of common features therebetween.

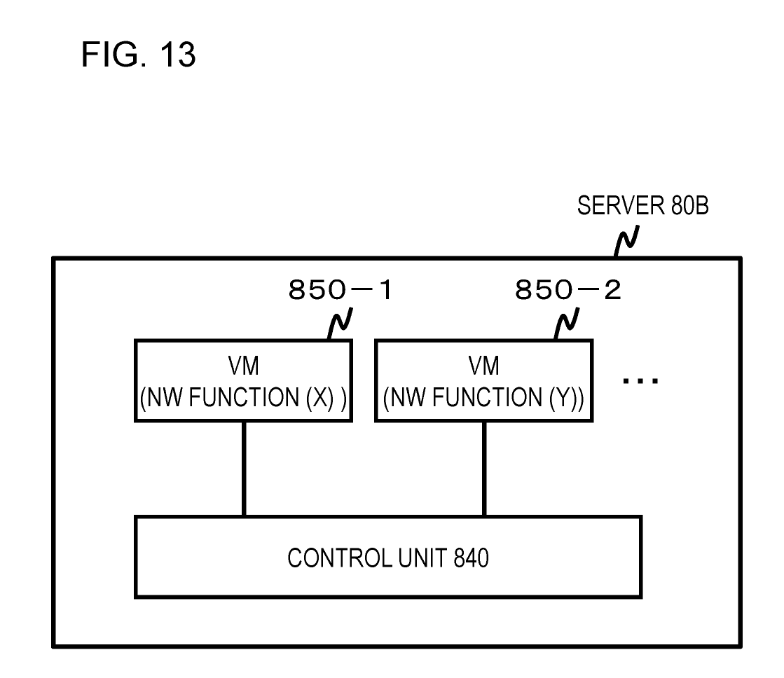

FIG. 13 illustrates a configuration example of a server 80B according to the fifth example embodiment. In FIG. 13, the server 80B includes a control unit 840 and VMs 850-1 to 850-N (N represents the upper limit of the number of VMs that can be activated. Hereinafter, any one of the VMs will be referred to as a “VM 850” when these VMs do not need to be distinguished from one another) that can provide predetermined NW functions, respectively. The server 80B is arranged in the offload path 50(B) in FIG. 1 and provides NW functions by using VMs.

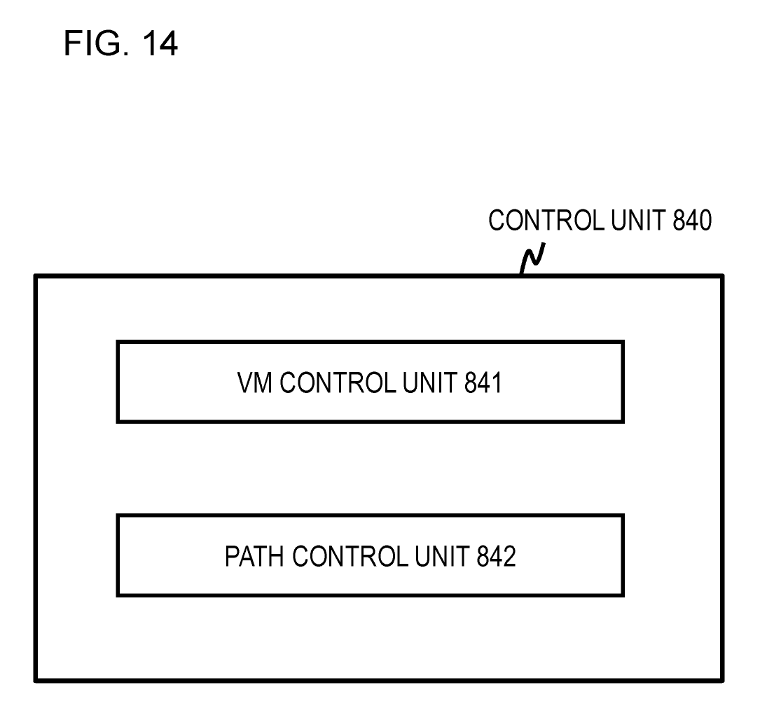

FIG. 14 illustrates a configuration example of the control unit 840 of the server 80B according to the fifth example embodiment. In the example in FIG. 14, the control unit 840 includes a VM control unit 841 that activates and manages a VM(s) 850 corresponding to a NW function(s) to be provided and a path control unit 842 that performs path control based on packet attribute information, etc., the path control including determination of whether to forward a packet to any of the VMs 850. The control unit 840 can be realized by a combination of a control program called a hypervisor and a vSwitch that operates on the hypervisor, for example.

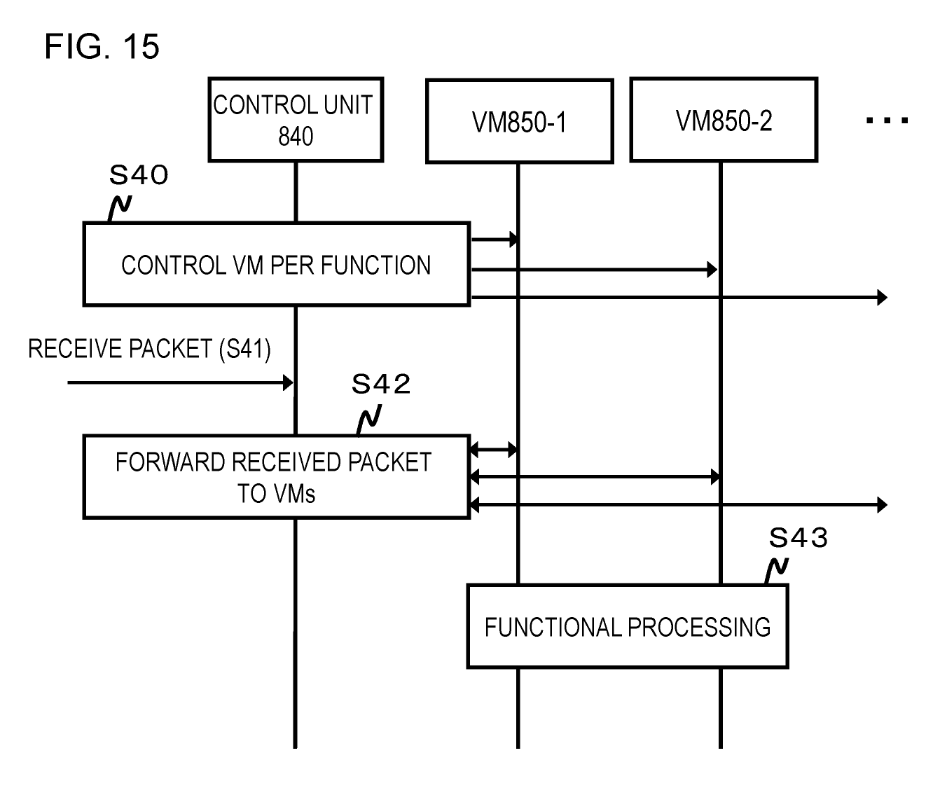

FIG. 15 illustrates an operation example of the server 80B according to the fifth example embodiment. First, the control unit 840 of the server 80B activates a VM(s) needed for providing a predetermined function(s) and controls the VM(s) 850 so that the corresponding function(s) can be provided (S40). The control apparatus 70 may specify the VM(s) needed for providing the corresponding function(s) (corresponding to the fourth means).

Next, when the control unit 840 receives a packet from the offload apparatus 20 in FIG. 1 (S41), for example, based on attribute information of the received packet, the control unit 840 determines a VM(s) 850 to which the packet needs to be forwarded, determines a path that realizes forwarding along the determined VM(s), and forwards the packet along the path (S42).

The VM(s) 850 that has received the packet performs processing based on the corresponding NW function(s) (S43).

As described above, according to the present example embodiment, the server 80B can provide a service chain in which necessary services are chained. In addition, according to the present example embodiment, the path control unit 842 can use a different service chain per packet.

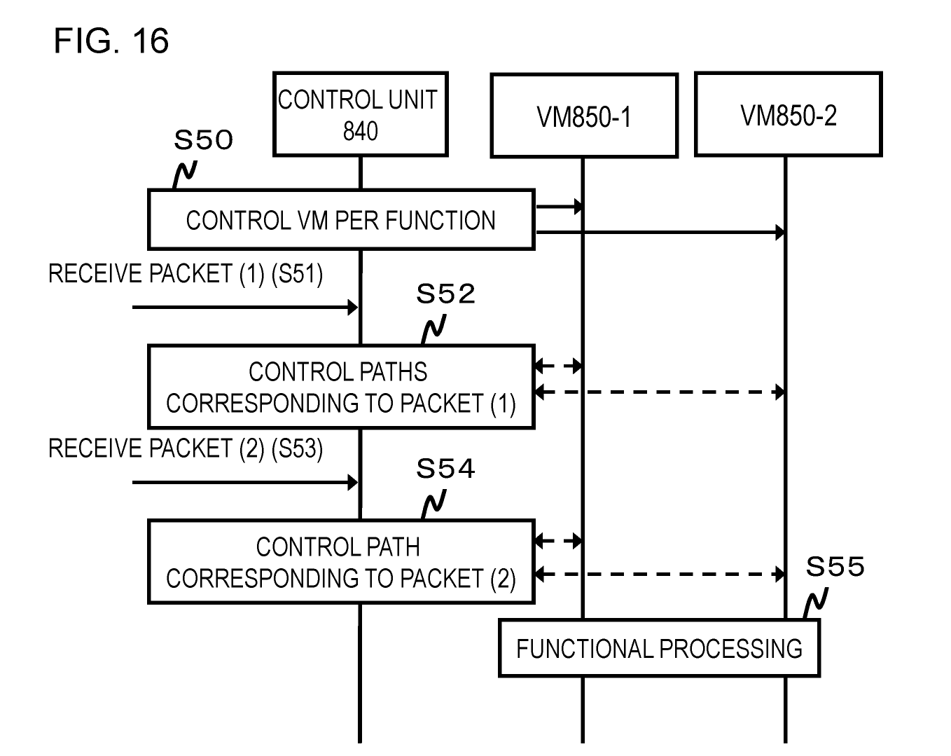

FIG. 16 illustrates another operation example of the server 80B according to the fifth example embodiment. First, the control unit 840 of the server 80B activates a VM(s) needed for providing a predetermined function(s) and controls the VM(s) 850 so that the corresponding function(s) can be provided (S50).

Next, when the control unit 840 receives a packet (1) from the offload apparatus 20 in FIG. 1 (S51), the control unit 840 identifies the packet (1) by referring to the attribute information of the packet and determines to forward the packet to the VMs 850-1 and 850-2. Next, the control unit 840 determines a path along which the packet is forwarded to the VMs 850-1 and 850-2 and forwards the packet along the path (S52).

Likewise, when the control unit 840 receives a packet (2) from the offload apparatus 20 in FIG. 1 (S53), the control unit 840 identifies the packet (2) by referring to the attribute information of the packet and determines to forward the packet only to the VM 850-1. Next, the control unit 840 determines a path along which the packet is forwarded to the VM 850-1 and forwards the packet along the path (S54).

The VM(s) 850 that has received the corresponding packet performs processing based on the corresponding NW function(s) (S55).

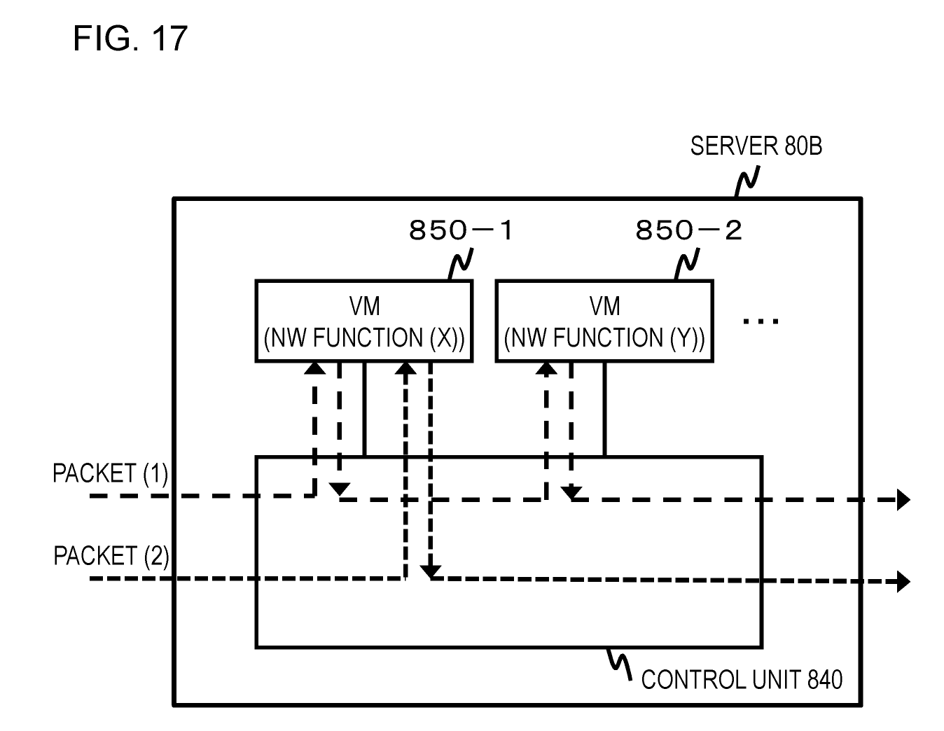

FIG. 17 illustrates the above packet-based path switching operation (the use of a different service chain per packet). In FIG. 17, since the NW functions (X) and (Y) need to be applied to the packet (1), the packet (1) is forwarded along a path passing through both the VMs 850-1 and 850-2 that provide the NW functions (X) and (Y). In contrast, since only the NW function (X) needs to be applied to the packet (2), the packet (2) is forwarded along a path passing through the VM 850-1 that provides the NW function (X).

As described above, according to the present example embodiment, based on an attribute(s) of a packet, a plurality of NW functions to be applied can be combined. In addition, the NW function(s) to be applied to the packet can freely be changed.

In addition, according to the present example embodiment, a NW function(s) to be applied to a packet can be switched dynamically. For example, in the case of an accounting function, a rate plan in which a measured rate and a flat rate are combined can be realized. More specifically, in this rate plan, the measured rate is used until a certain packet amount is used. When the number of packets reaches a certain value, the counting function is turned off, and thereafter the flat rate is used.

In the fifth example embodiment, while the control unit 840 determines the VM(s) 850 to which a received packet needs to be forwarded based on packet attribute information, etc., the offload apparatus 20 may perform a part of or all the determination processing. In this case, the offload apparatus 20 may provide the server 80B with a necessary instruction so that the control unit 840 can select a VM(s).

In addition, in the present example embodiment, too, as illustrated in FIG. 12, a forwarding apparatus may be arranged upstream of the server 80B. In this way, packets received by the server 80B can be selected.

### Sixth Example Embodiment

Next, a sixth example embodiment will be described with reference to the drawings. In the sixth example embodiment, the switching of the service chain performed by the server according to the fifth example embodiment is performed based on an identifier given to an individual packet. The following description will be made with a focus on the difference between the fifth and sixth example embodiments, omitting description of common features therebetween.

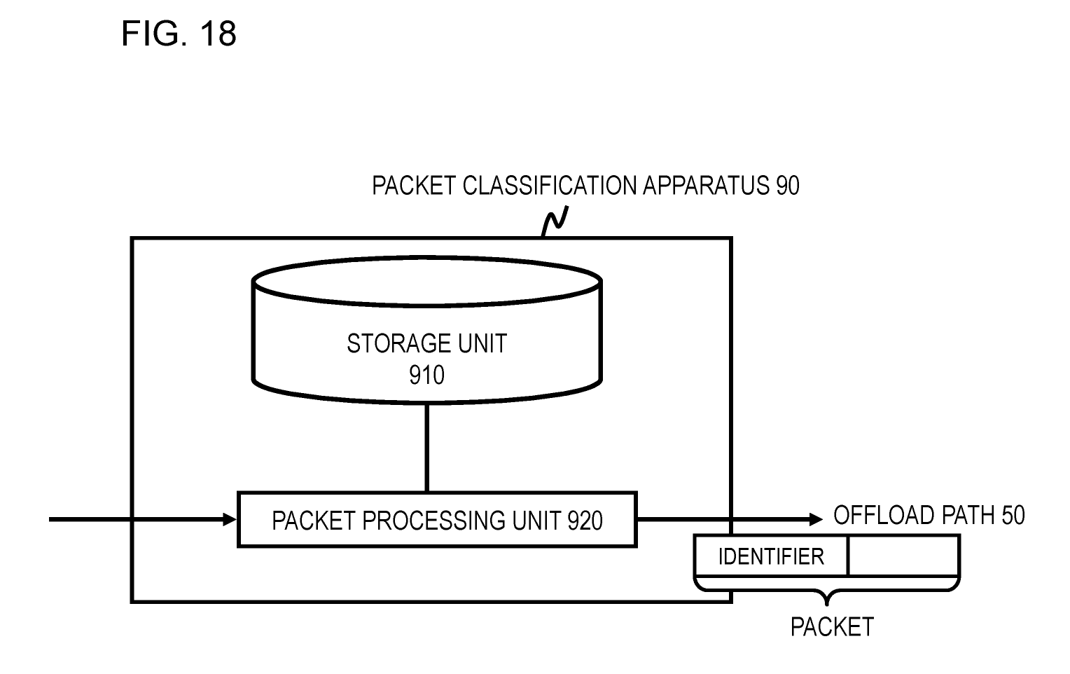

FIG. 18 illustrates a configuration example of a packet classification apparatus 90 arranged upstream of the server 80B used in the sixth example embodiment. In FIG. 18, the packet classification apparatus 90 includes a storage unit 910 and a packet processing unit 920.

The storage unit 910 holds an identifier assignment rule(s) that defines an identifier to be assigned based on an attribute(s) of a packet. The control apparatus 70 may set the identifier assignment rules.

The packet processing unit 920 refers to the identifier assignment rule(s) held in the storage unit 910 and assigns an identifier to an individual received packet. In the present example embodiment, while an identifier is added to an individual packet by attaching an external header holding the identifier, the method of adding identifiers is not limited to the above method. For example, an identifier may be stored in a predetermined field in an original packet header. Alternatively, the function corresponding to the packet classification apparatus 90 may be performed by the offload apparatus 20.

In addition, the control unit 840 of the server 80B according to the present example embodiment determines a VM(s) to which a received packet needs to be forwarded and a path that realizes the forwarding to the VM(s) based on the identifier.

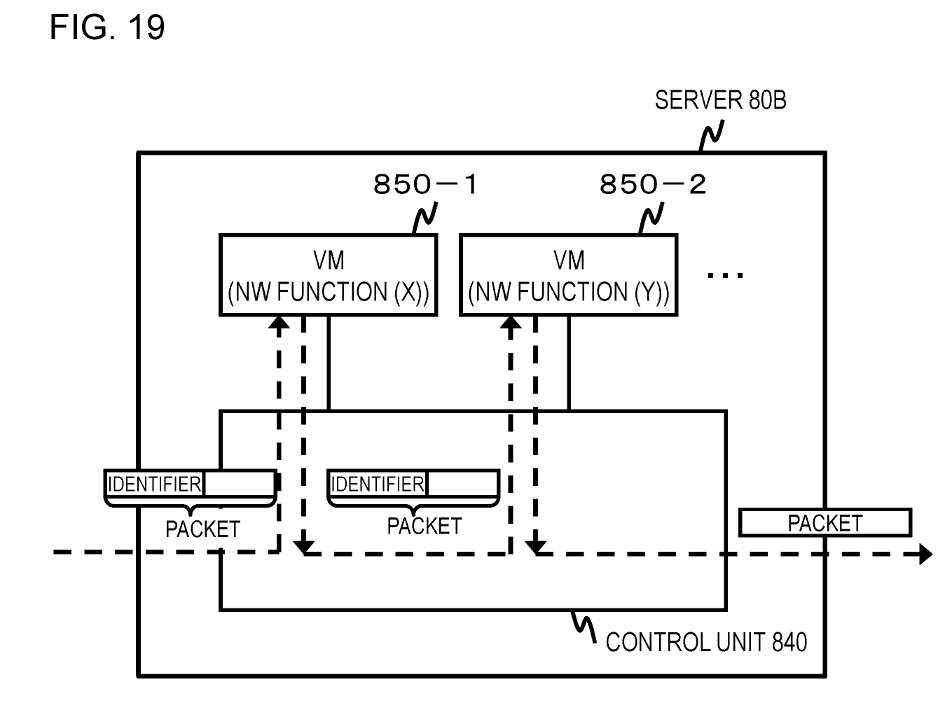

FIG. 19 illustrates a path switching operation (the use of a different service chain per packet) using an identifier given by the packet classification apparatus 90. In FIG. 19, since a packet given a certain identifier needs to undergo the NW functions (X) and (Y), the packet is forwarded along a path passing through both the VMs 850-1 and 850-2 that provide the respective NW functions (X) and (Y). Of course, a packet given a different identifier may be forwarded along a path passing through either the VM 850-1 that provides the NW function (X) or the VM 850-2 that provides the NW function (Y) or a path passing through neither of the VMs. In addition, a packet given a different identifier may be forwarded along a path passing through a different VM 850 that provides an NW function (Z) in addition to the VMs 850-1 and 850-2.

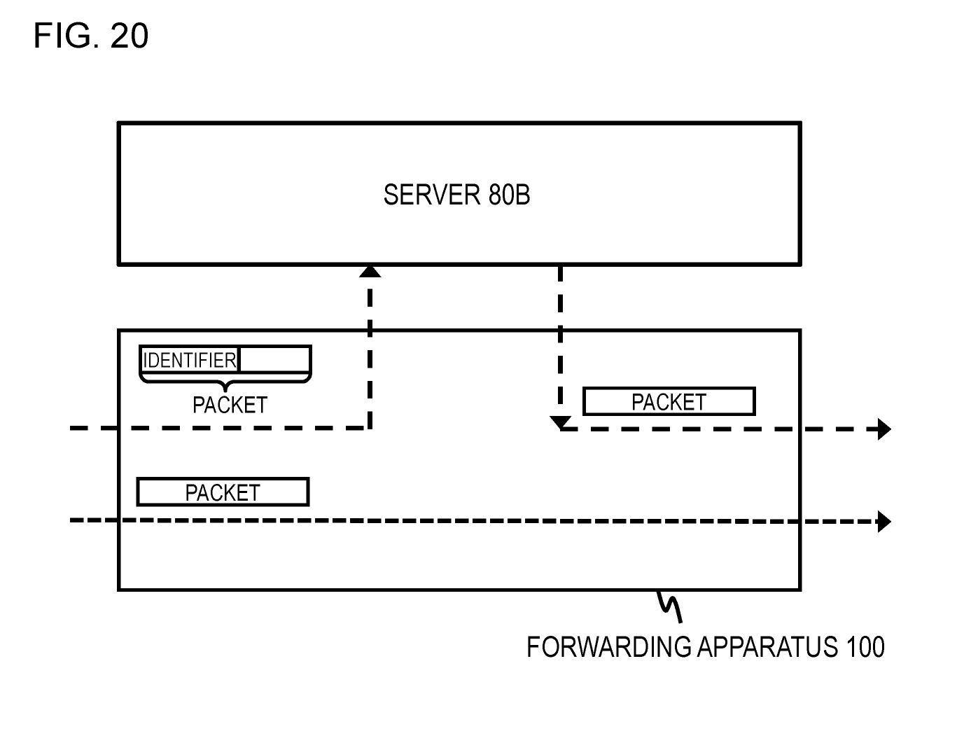

As described above, according to the present example embodiment, a correspondence relationship between packets and NW functions can be managed by using identifiers. In addition, in the present example embodiment, too, as illustrated in FIG. 20, a forwarding apparatus 100 may be arranged upstream of the server 80B. In this way, the packets received by the server 80B can be selected. In addition, the forwarding apparatus 100 illustrated in FIG. 20 may have the function corresponding to the packet classification apparatus 90. The forwarding apparatus 100 including such packet classification function can be realized by using an OpenFlow switch in which flow entries for rewriting headers are set.

### Seventh Example Embodiment

Next, a seventh example embodiment will be described with reference to the drawings. In the seventh example embodiment, an operation management apparatus that gives necessary instructions to the control apparatus according to the second example embodiment is arranged. The following description will be made with a focus on the difference between the second and seventh example embodiments, omitting description of common features therebetween.

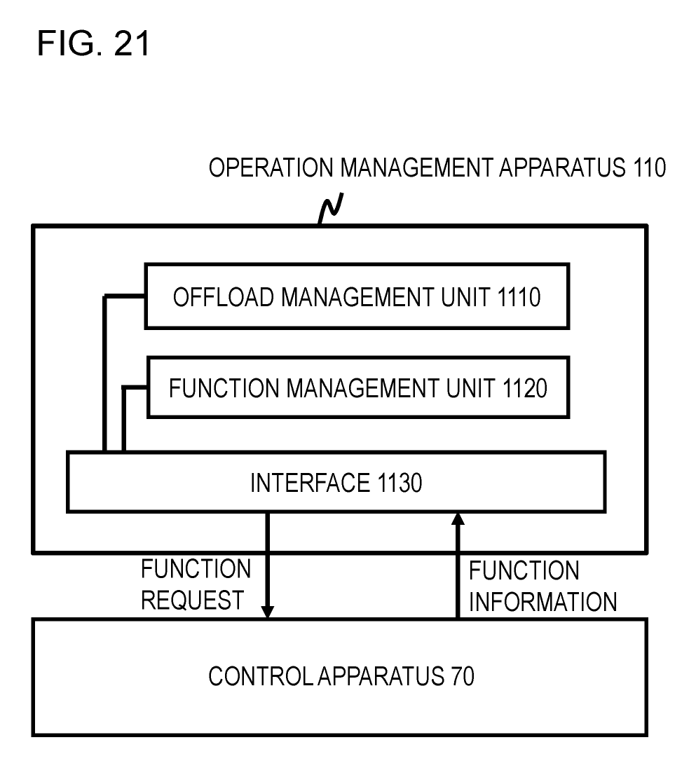

FIG. 21 illustrates a configuration example of an operation management apparatus 110 used in the seventh example embodiment. In FIG. 21, the operation management apparatus 110 includes an offload management unit 1110, a function management unit 1120, and an interface 1130.

The offload management unit 1110 receives an operation content about the table illustrated in FIG. 6 from a network operator and updates the table held in the storage unit 730 in the control apparatus 70. For example, the offload management unit 1110 receives an operation of changing the offload setting of the entry corresponding to the condition (a) in FIG. 6 from NOT APPLIED to APPLIED and updates the content in the storage unit 730 accordingly. In this way, after this update, the packets that match the condition (a) are treated as offload target packets.

The function management unit 1120 receives an operation content about the tables illustrated in FIGS. 6 and 7 from the network operator and updates the tables held in the storage unit 730 in the control unit 70. For example, the function management unit 1120 receives an operation of changing some of the NW functions of the entry corresponding to the condition (b) in FIG. 6 from NOT APPLIED to APPLIED and updates the content in the storage unit 730 accordingly. In this way, after this update, the NW functions to be applied to the packets that match the condition (b) are changed.

In the above examples, the offload management unit 1110 and the function management unit 1120 directly update the tables held in the storage unit 730 in the control apparatus 70. However, the offload management unit 1110 and the function management unit 1120 may receive a control policy that defines an update policy of a table and set the control policy in the control apparatus 70. For example, by setting a control policy for changing the offload setting corresponding to the condition (a) in the table in FIG. 6 from APPLIED (NOT APPLIED) to NOT APPLIED (APPLIED) or a control policy for adding a specific entry to the table in FIG. 6 at a specific time, the table can automatically be changed. Likewise, a control policy for dynamically changing the content of a forwarding path field in the table in FIG. 7 based on a network load, etc. may be set.

In addition, the seventh example embodiment has been described by using an example in which the operation management apparatus 110 controls the control apparatus 70. However, instead of the control apparatus 70, the operation management apparatus 110 may control the offload apparatus in FIG. 1 or the packet classification apparatus 90 in FIG. 18. In addition, the operation management apparatus 110 may set control policies for the servers described in the third to sixth example embodiments.

### Eighth Example Embodiment

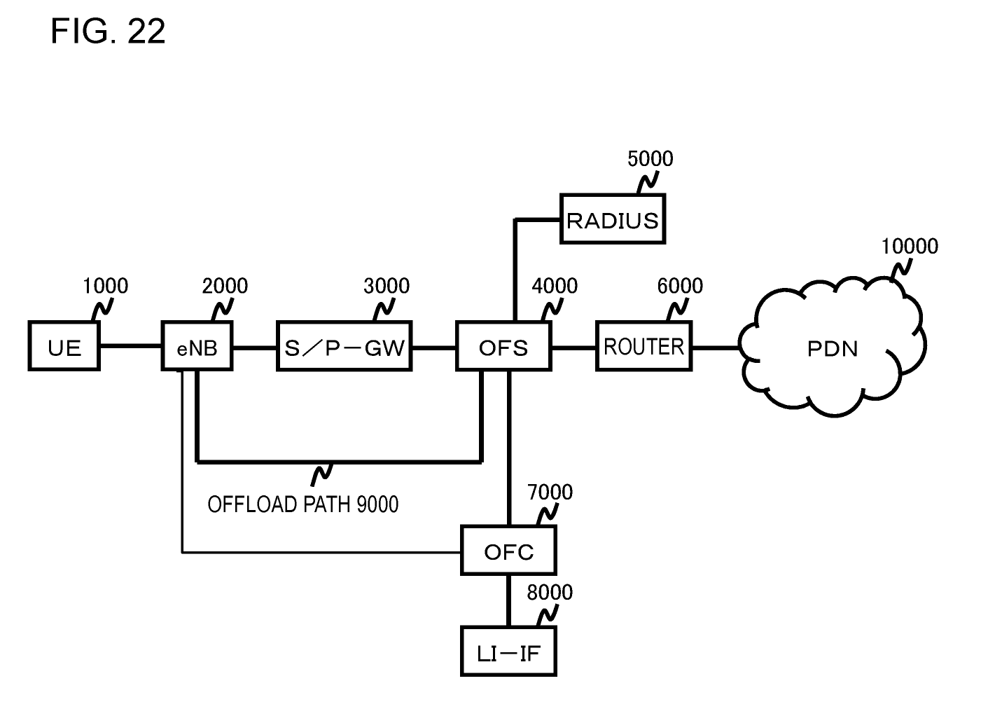

Next, an eighth example embodiment will be described in detail with reference to the drawings. In the eighth example embodiment, the present disclosure is applied to offload control in a mobile network. FIG. 22 illustrates a network configuration according to the eighth example embodiment.

FIG. 22 illustrates a configuration in which a mobile terminal UE (user entity) 1000 is connected to a PDN (packet data network) 10000 via a base station eNB 2000 which functions as the offload apparatus 20, an S/P-GW (S-GW+P-GW) 3000 which is a mobile core apparatus, an OFS (OpenFlow switch) 4000, and a router 6000. In addition, a RADIUS server 5000, an OFC (OpenFlow controller) 7000, and an LI-IF 8000 which is an interface for receiving requests for execution of LI (lawful interception) are connected to the OFS 4000.

The base station eNB 2000 connects to the UE 1000 within its service area by a radio link. In addition, an offload path 9000 that bypasses the S/P-GW 3000 is set between the eNB 2000 and the OFS 4000.

The OFS 4000 searches the flow entries held therein for a flow entry having a match condition(s) that matches a received packet and performs a processing content(s) (forwarding in a specified path, header rewriting, packet dropping, etc.) defined by the flow entry. In addition, when the OFS 4000 does not find a flow entry having a match condition(s) that matches a received packet, the OFS 4000 transmits information about the received packet to the OFC 7000 and requests the OFC 7000 to set a corresponding flow entry.

The RADIUS server 5000 functions as an AAA (Authentication, Authorization, Accounting) server that controls authentication, authorization, and accounting.

The router 6000 is a layer-3 apparatus that performs relay control. In FIG. 22, an MME, an HSS (Home Subscriber Server), a PCRF (Policy and Charging Rule Function) for performing service-based priority control, setting an accounting rule(s), etc. are omitted.

The OFC 7000 corresponds to the control apparatus 70 according to the second example embodiment described above and controls the offload function of the OFS 4000.

The LI-IF 8000 is connected to the OFC 7000 and further connected to an interception apparatus (LEMF: law enforcement monitoring facility) (not illustrated) of a law enforcement agency (LEA) that has the authority to execute legitimate interception.

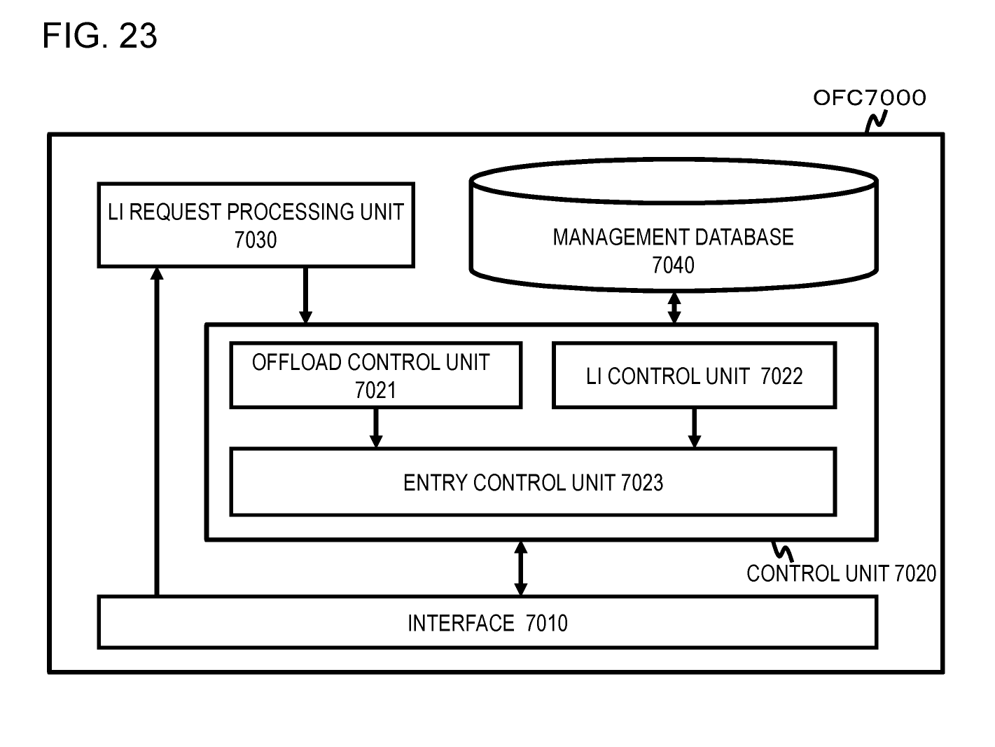

FIG. 23 is a block diagram illustrating a detailed configuration example of the OFC 7000. As illustrated in FIG. 23, the OFC 7000 according to the present example embodiment includes an interface 7010, a control unit 7020, an LI request processing unit 7030, and a management database 7040. The interface 7010, the control unit 7020, and the management database 7040 in FIG. 23 correspond to the interface 710, the control unit 720, and the storage unit 730 in the control apparatus 70 illustrated in FIG. 4, respectively. Namely, the OFC 7000 in FIG. 23 includes the LI request processing unit 7030 in addition to the elements of the control apparatus 70 in FIG. 4.

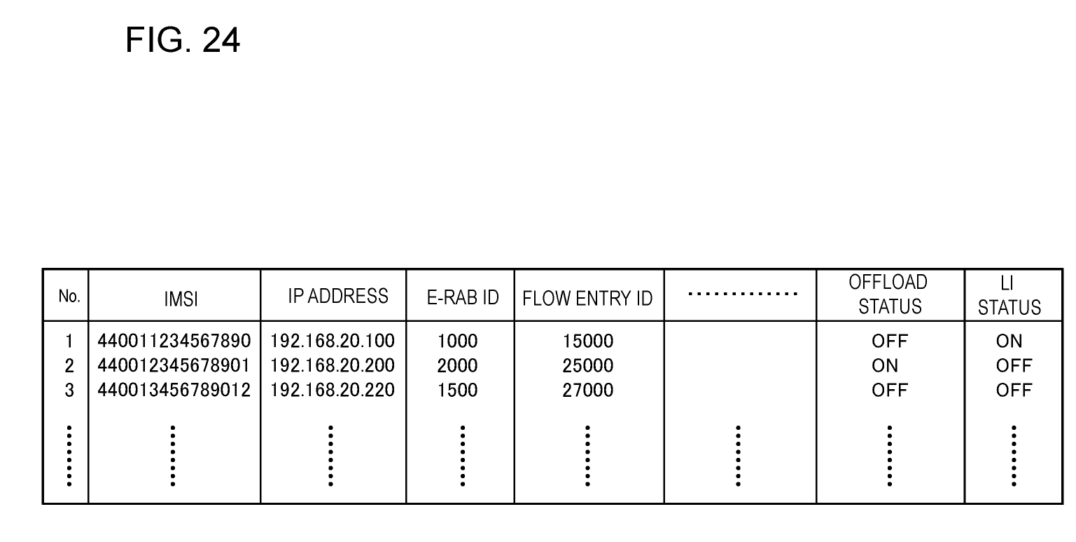

The management database 7040 holds a UE information management table illustrated in FIG. 24. Next, the UE information management table will be described with reference to FIG. 24. For example, the UE information management table has fields at least for an IMSI (International Mobile Subscriber Identity) which is unique information used for determining an individual user, an IP (Internet Protocol) address allocated to an individual terminal, an E-RABID which is a wireless bearer identifier, a flow entry ID set in the OFS 4000, the use status of the offload function, and the use status of the LI function per terminal registered in the mobile network. The fields for “IMSI” to “flow entry ID” in FIG. 24 correspond to the “identification condition” field in FIG. 6. The fields for “offload status” and “LI status” correspond to the “offload” field and the “NW function” field in FIG. 6, respectively. However, the fields held in the UE information management table are not limited to the above items. For example, if the network is managed by MSISDNs, in place of the IMSIs, the MSISDNs may be used as the IDs for determining individual users or may be added to the table in a different field. As for the E-RABIDs, since any information can be used as long as the information can determine the wireless bearer, information such as TMSIs and TEIDs may be used in place of the E-RABIDs. To improve the accuracy of the information to be managed, fields that correspond to TMSIs and TEIDs may be added. In addition, a VLANID field may be added to the UE information management table. As for the flow entry IDs, as long as the individual flow entries set in the OFS 4000 can be determined, an alternative method may be used. Namely, if there is an alternative method, the flow entry IDs do not necessarily need to be registered. For example, a flow entry can be determined by searching the flow entries set in the OFS by using the IP address of a terminal as a key. In such case, however, since the search has to be performed on a great number of flow entries each time, it takes time to perform a flow entry changing operation for offload control. In addition, while only the field for the LI status is arranged in the example in FIG. 24, as in FIG. 6, another field for setting the necessity of application of a different mobile core function such as accounting may be added. Alternatively, the statuses of a plurality of mobile core functions can be generalized and managed by using a single field as a status of the mobile core functions.

In addition, the management database 7040 holds information such as terminal information and network topology information that the control unit 7020 uses to create flow entries to be set in the OFS 4000. The management database 7040 may hold the created flow entries and provide an appropriate flow entry in response to a request from the OFS 4000.

The control unit 7020 includes an offload control unit 7021, an LI control unit 7022, and an entry control unit 7023.

When receiving a flow entry creation request from the OFS 4000, the offload control unit 7021 refers to the management database 7040, determines whether to apply offload to the target packet, and transmits the determination result to the entry control unit 7023.

When receiving a flow entry creation request from the OFS 4000, the LI control unit 7022 refers to the management database 7040, determines whether to apply LI to the target packet, and transmits the determination result to the entry control unit 7023.

Based on the determination results received from the offload control unit 7021 and the LI control unit 7022, the entry control unit 7023 determines the necessity of offload and the necessity of application of the LI function, creates a flow entry for forwarding the packet along a path that realizes the determination results, and sets the flow entry in the OFS 4000. In addition, the entry control unit 7023 notifies the eNB 2000 of the necessity of offload and the necessity of application of the LI function.

The LI request processing unit 7030 receives an LI request or end request regarding a communication specifying an IMSI, an IP address, or the like from the LI-IF 8000 and notifies the control unit 7020 of the request.

Compared with the second example embodiment, the eighth example embodiment operates as follows.
(1-1) When the control unit 7020 receives an LI request specifying an IMSI, an IP address, or the like from the LI request processing unit 7030, the control unit 7020 refers to the management database 7040, searches for a matching entry, and updates the content of the LI status field. For example, when the LI status is changed from OFF to ON, the control unit 7020 checks the offload status of the matching entry. If the offload status is ON (offload is being applied), the control unit 7020 switches the status to OFF (offload is not applied) (re-selection of the path). Next, the control unit 7020 instructs the OFS 4000 and the eNB 2000 to stop forwarding packets via the offload path 9000 and switch the path to forward the packets via the S/P-GW 3000.
(1-2) In contrast, when the LI status is changed from ON to OFF, the control unit 7020 checks the offload status of the matching entry. If the offload status is OFF (offload is not being applied), the control unit 7020 switches the status to ON (offload is applied) (re-selection of the path). Next, the control unit 7020 instructs the OFS 4000 and the eNB 2000 to stop forwarding packets via the S/P-GW 3000 and switch the path to forward the packets via the offload path 9000.
(2-1) When the OFC 7000 receives an offload determination request specifying an IMSI, an IP address, or the like from the base station eNB 2000 or the OFS, the control unit 7020 of the OFC 7000 refers to the management database 7040, searches for a matching entry, and refers to the LI status field of the matching entry. If the LI status field of the matching entry is ON (LI is being performed), the control unit 7020 instructs the OFS 4000 and the eNB 2000 to forward packets via the S/P-GW 3000 regardless of the value set in the offload status field.
(2-2) In contrast, if the LI status field of the matching entry is OFF (LI is not being performed), the control unit 7020 changes the value set in the offload field to ON (offload is applied) and instructs the OFS 4000 and the eNB 2000 to forward packets via the offload path 9000.

As described above, according to the present example embodiment, the offload function and the NW function(s) such as accounting and LI can simultaneously be realized.

### Ninth Example Embodiment

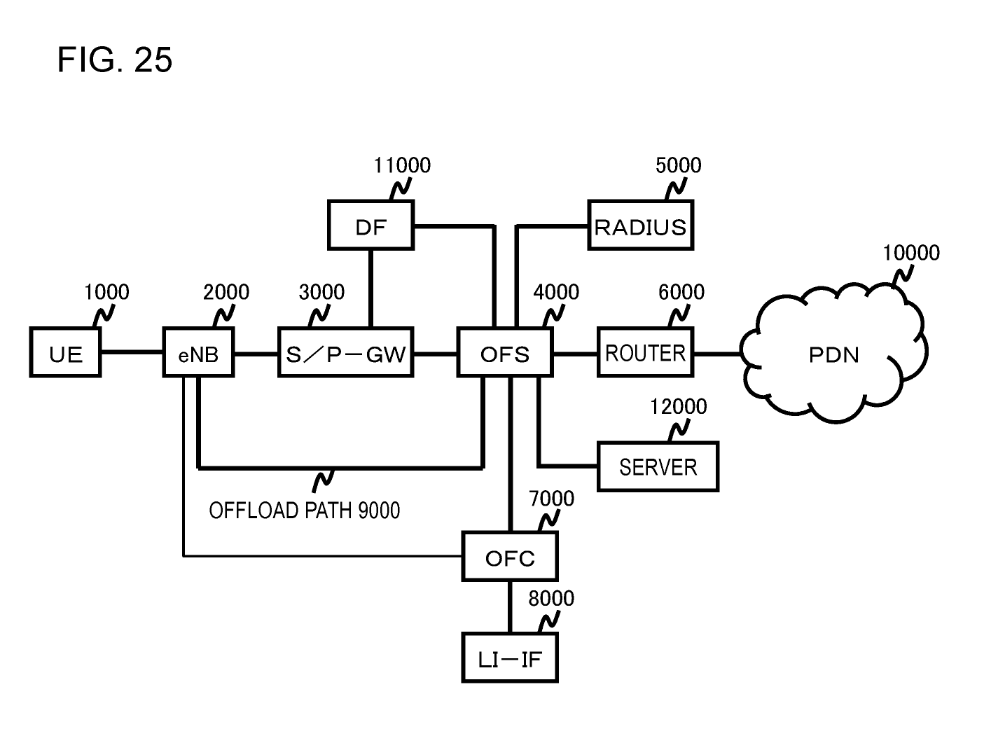

Next, a ninth example embodiment will be described in detail with reference to the drawings. The configuration according to the ninth example embodiment includes a server providing an NW function(s) in addition to the elements according to the eighth example embodiment. FIG. 25 illustrates a network configuration according to the ninth example embodiment. As illustrated in FIG. 25, the ninth example embodiment differs from the eighth example embodiment in that an interception packet reception server 11000 called a delivery function (DF) and a server 12000 are connected to the OFS 4000.

The server 12000 corresponds to the servers 80 to 80B in the third to sixth example embodiments and applies the NW function (X) to packets received from the OFS 4000.

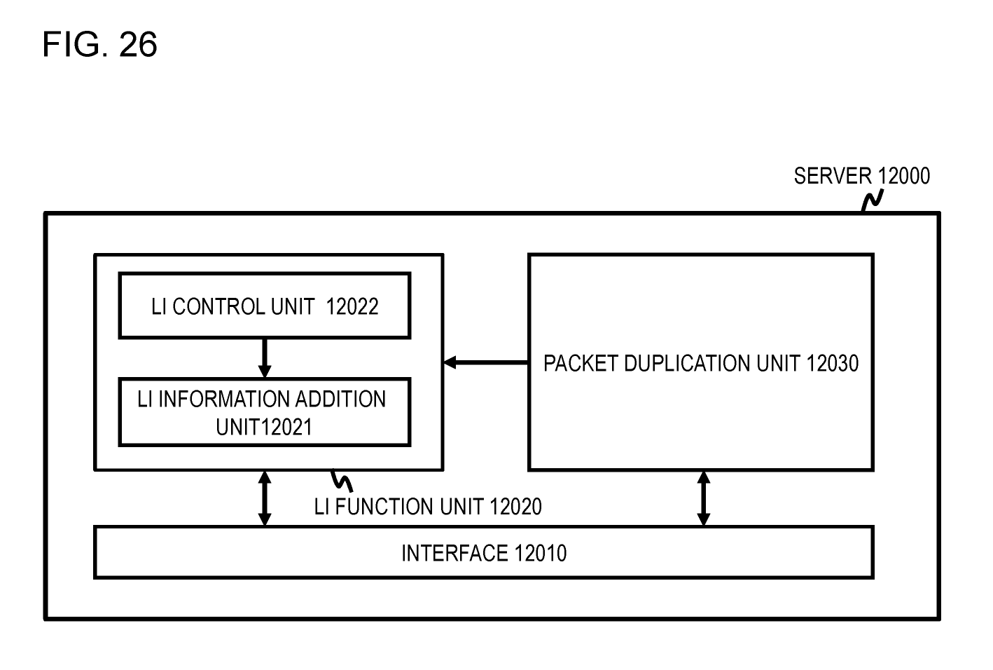

FIG. 26 illustrates a configuration example of the server 12000. As illustrated in FIG. 26, the server 12000 includes an interface 12010, an LI function unit 12020, and a packet duplication unit 12030.

The interface 12010 is the same as the interface 810 of the server 80A according to the fourth example embodiment illustrated in FIG. 11.

When the packet duplication unit 12030 receives a packet from the OFS 4000, the packet duplication unit 12030 duplicates the packet and transmits the duplicate to the LI function unit 12020. In addition, the packet duplication unit 12030 transmits the original packet back to the OFS 4000 side.

The LI function unit 12020 includes an LI control unit 12022 and an LI information addition unit 12021. When a received packet is an LI control target packet, by using the LI control target packet, the LI control unit 12022 transmits an LI start or end instruction and LI information to the LI information addition unit 12021. The LI information addition unit 12021 attaches the LI information instructed by the LI control unit 12022 to an interception target packet and outputs the packet. The DF 11000 is set as a forwarding destination of the packet to which the LI information has been attached by the LI information addition unit 12021, and the packet is forwarded to the DF 11000 via the OFS 4000. While the DF 11000 is connected to the OFS 4000 in the example in FIG. 25, the DF 11000 may be connected to the server 12000, and the packet to which the LI information has been attached may directly be transmitted from the server 12000 to the DF 11000.

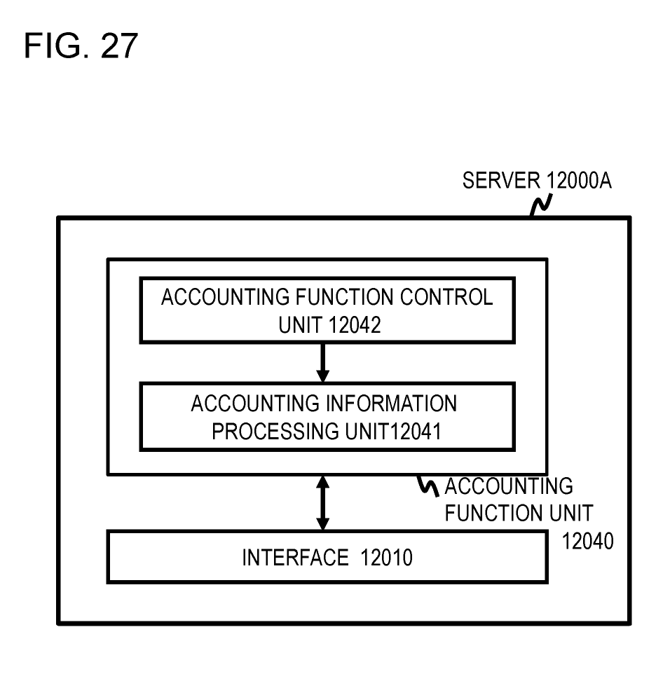

In addition, in place of the server 12000, a server 12000A that provides an accounting function may be arranged. FIG. 27 illustrates a configuration example of the server 12000A. As illustrated in FIG. 27, the server 12000A includes an interface 12010 and an accounting function unit 12040.

The accounting function unit 12040 includes an accounting information processing unit 12041 and an accounting function control unit 12042. The accounting function control unit 12042 transmits an accounting processing start or end instruction to the accounting information processing unit 12041 in accordance with a predetermined charging start or end condition. In accordance with such an instruction from the accounting function control unit 12042, the accounting function information unit 12041 performs its accounting processing based on a packet received via the interface 12010.

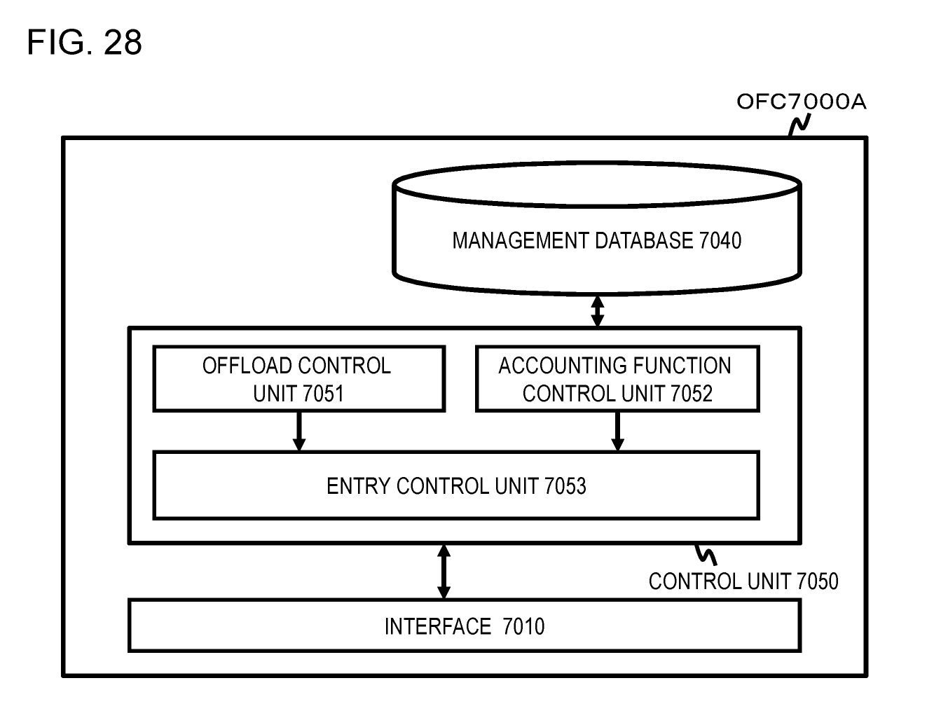

FIG. 28 illustrates a configuration example of an OFC 7000A when the server 12000A that provides the accounting function is arranged. The OFC 7000A differs from the OFC 7000 illustrated in FIG. 23 in that, in place of the LI control unit 7022, an accounting function control unit 7052 is arranged in the control unit 7050.

As with the offload control unit 7021 in the control unit 7020 of the OFC 7000 according to the eighth example embodiment, when an offload control unit 7051 receives a flow entry creation request from the OFS 4000, the offload control unit 7051 refers to a management database 7040, determines whether offload needs to be applied to the target packet, and transmits the determination result to an entry control unit 7053.

When the accounting function control unit 7052 receives a flow entry creation request from the OFS 4000, the accounting function control unit 7052 refers to the management database 7040, determines whether the accounting function needs to be applied to the target packet, and transmits the determination result to the entry control unit 7053.

Based on the determination results received from the offload control unit 7051 and the accounting function control unit 7052, the entry control unit 7053 determines the necessity of offload and the necessity of application of the accounting function, creates a flow entry for forwarding the packet to a path that realizes the determination results, and sets the flow entry in the OFS 4000. In addition, the entry control unit 7053 notifies the eNB 2000 of the necessity of offload and the necessity of application of the accounting function.

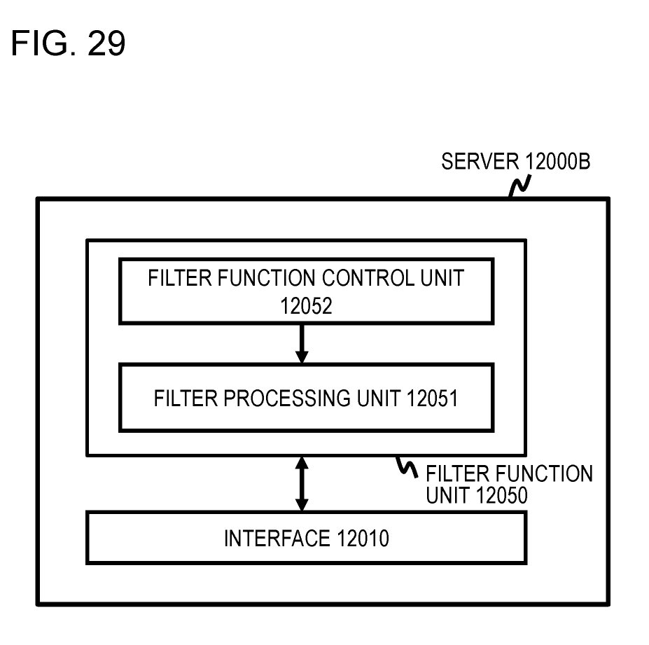

In place of the server 12000, a server 12000B that provides a filter function may be arranged. FIG. 29 illustrates a configuration example of the server 12000B. As illustrated in FIG. 29, the server 12000B includes an interface 12010 and a filter function unit 12050.

The filter function unit 12050 includes a filter processing unit 12051 and a filter function control unit 12052. In accordance with a predetermined filter setting, the filter function control unit 12052 instructs the filter processing unit 12051 to turn on and off the filter function and provides the filter function control unit 12052 with filter conditions. Instructed by the filter function control unit 12052, the filter processing unit 12051 performs its filter processing based on a packet received via the interface 12010. Examples of the filter processing include filter processing against harmful contents for children, etc.

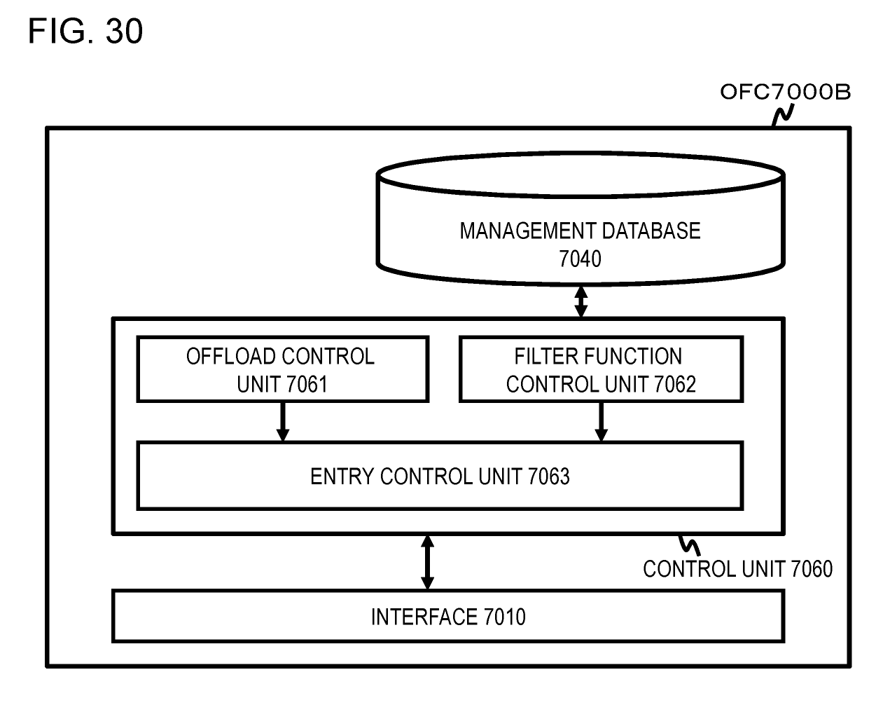

FIG. 30 illustrates a configuration example of an OFC 7000B when the server 12000B that provides the filter function is arranged. The OFC 7000B differs from the OFC 7000 illustrated in FIG. 23 in that, in place of the LI control unit 7022, a filter function control unit 7062 is arranged in a control unit 7060.

As with the offload control unit 7021 in the control unit 7020 of the OFC 7000 according to the eighth example embodiment, when an offload control unit 7061 receives a flow entry creation request from the OFS 4000, the offload control unit 7061 refers to the management database 7040, determines whether offload needs to be applied to the target packet, and transmits the determination result to an entry control unit 7063.

When the filter function control unit 7062 receives a flow entry creation request from the OFS 4000, the filter function control unit 7062 refers to a management database 7040, determines whether the filter function needs to be applied to the target packet, and transmits the determination result to the entry control unit 7063.

Based on the determination results received from the offload control unit 7061 and the filter function control unit 7062, the entry control unit 7063 determines the necessity of offload and the necessity of application of the filter function, creates a flow entry for forwarding the packet to a path that realizes the determination results, and sets the flow entry in the OFS 4000. In addition, the entry control unit 7063 notifies the eNB 2000 of the necessity of offload and the necessity of application of the filter function.

The LI function unit 12020 and the packet duplication unit 12030 correspond to examples of the NW function unit 820 and the information extraction unit 830 of the server 80A according to the fourth example embodiment illustrated in FIG. 11, respectively. The accounting function unit 12040 and the filter function unit 12050 correspond to examples of the NW function unit 820 of the server 80 according to the third example embodiment illustrated in FIG. 9. Of course, the NW function units 820 in the servers 80 to 80A are not limited to those providing the LI function, the accounting processing, and the filter processing. These NW function units 820 may be configured to provide various kinds of NW functions. In addition, as described in the fifth and sixth example embodiments, the functions that correspond to the above servers 12000, 12000A, and 12000B may be realized by VMs. In such a case, arbitrary NW functions may be selected to create a service chain so that the service chain can be applied to a certain flow.

As described above, according to the present example embodiment, in addition to the functions according to the eighth example embodiment, the LI function, the accounting function, and the filter function can be provided on the offload network side. Thus, for example, even when an LI request is received from the LI-IF 8000, the offload does not need to be ended immediately, which is an advantageous effect. In addition, according to the present example embodiment, even traffic that is not being offloaded can be switched to take an offload path, as long as a condition(s) is satisfied. This is because the server 12000 (12000A, 12000B) is connected to the OFS 4000 on the offload path side and a certain NW function(s) can be selectively applied.

### Tenth Example Embodiment

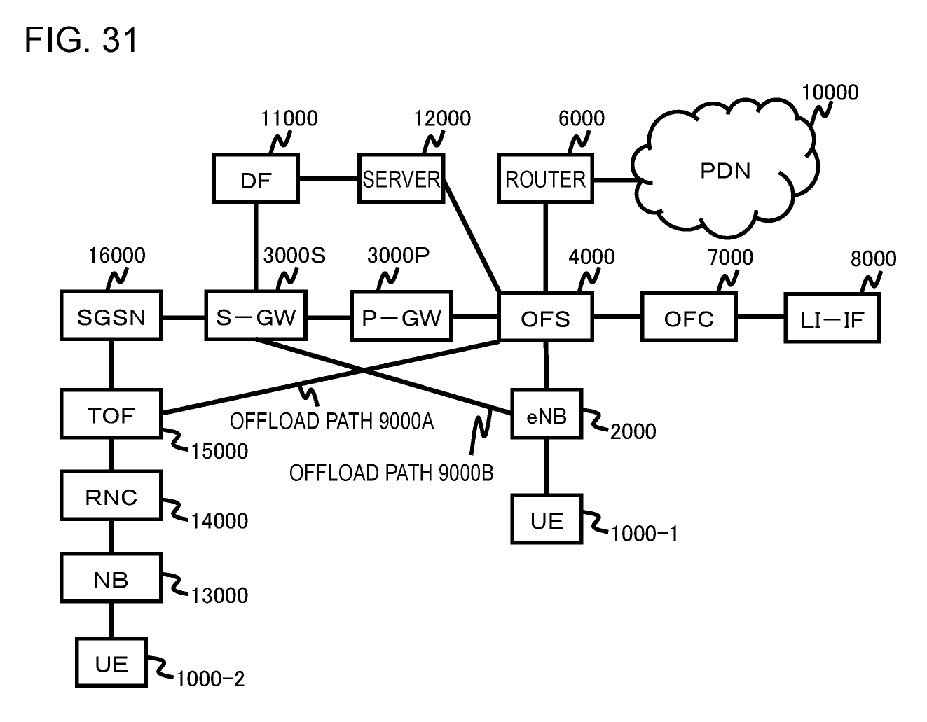

Next, tenth to twelfth example embodiments which are variations of the ninth example embodiment will be described. FIG. 31 illustrates a configuration example of a communication system according to the tenth example embodiment. This communication system differs from that according to the ninth example embodiment illustrated in FIG. 25 in that a first UE 1000-1 is connected to an OFS 4000 and an S-GW 3000S via a base station eNB 2000, and a second UE 1000-2 is connected to the OFS 4000 and SGSN (Serving GPRS Support Node; also called a subscriber packet exchange apparatus) 16000 via a base station NB 13000, a radio network controller (RNC) 14000, and a TOF (traffic offload apparatus) 15000. Accordingly, an offload path 9000B is prepared on the base station eNB 2000 side and an offload path 9000A is prepared on the TOF (traffic offload apparatus) 15000 side.

In the communication system according to the present example embodiment, an OFC 7000 that controls the offload function operates in the same way as that according to the ninth example embodiment illustrated in FIG. 25. Namely, when the OFC 7000 receives a connection request in which offload is requested from the TOF 15000 via the OFS 4000, the OFC 7000 performs path control based on whether an offload target terminal (the UE 1000-2 in FIG. 31) is using the LI function and whether offload is possible by using the server 12000. For example, when the UE 1000-2 is not using the LI function, the OFC 7000 transmits a flow entry for switching the path to the offload path to the OFS 4000 and instructs the TOF 15000 to forward packets via the offload path 9000A. When the TOF 15000 receives the instruction, the TOF 15000 applies offload to an offload target bearer and starts communication via the offload path 9000A. In contrast, when the UE 1000-2 is using the LI function, the OFC 7000 instructs the TOF 15000 not to apply offload. When receiving the instruction, the TOF 15000 performs communication by using the path passing through the mobile core (SGSN 16000).

Regarding the control of the offload function in association with the use of the LI function, the OFC 7000 according to the present example embodiment operates in the same way as that according to the eighth example embodiment. Namely, when the OFC 7000 receives an LI request from an LI-IF 8000, the OFC 7000 performs control processing based on the offload status of an LI target terminal. For example, assuming that the UE 1000-2 is an LI request target and its communication is not being offloaded, the OFC 7000 that has received the LI request does not perform any control and allows the TOF 15000 to continue the communication via the mobile core. In contrast, assuming that the UE 1000-2 is an LI request target and its communication is being offloaded, the OFC 7000 transmits a flow entry for switching the path to the path passing through the mobile core to the OFS 4000 and instructs the TOF 15000 to stop the application of offload. When the TOF 15000 receives the instruction to stop the application of offload (not to apply offload), the TOF 15000 ends the offload operation on the offload target bearer and switches the path to the path passing through the mobile core (the SGSN 16000). The offload status and the LI status are registered and managed in the UE information management table in the management database 7040 in the OFC 7000 in the same way as in the eighth example embodiment.

In addition, in the configuration example in FIG. 31, the server 12000 is connected to the OFS 4000, as in the ninth example embodiment. When the server 12000 includes the LI function, even when the UE 1000-2 is an LI request target and its communication is being offloaded, the OFC 7000 may transmit a flow entry for instructing packet forwarding to the server 12000 to the OFS 4000 and allow the TOF 15000 to continue the application of offload.

### Eleventh Example Embodiment

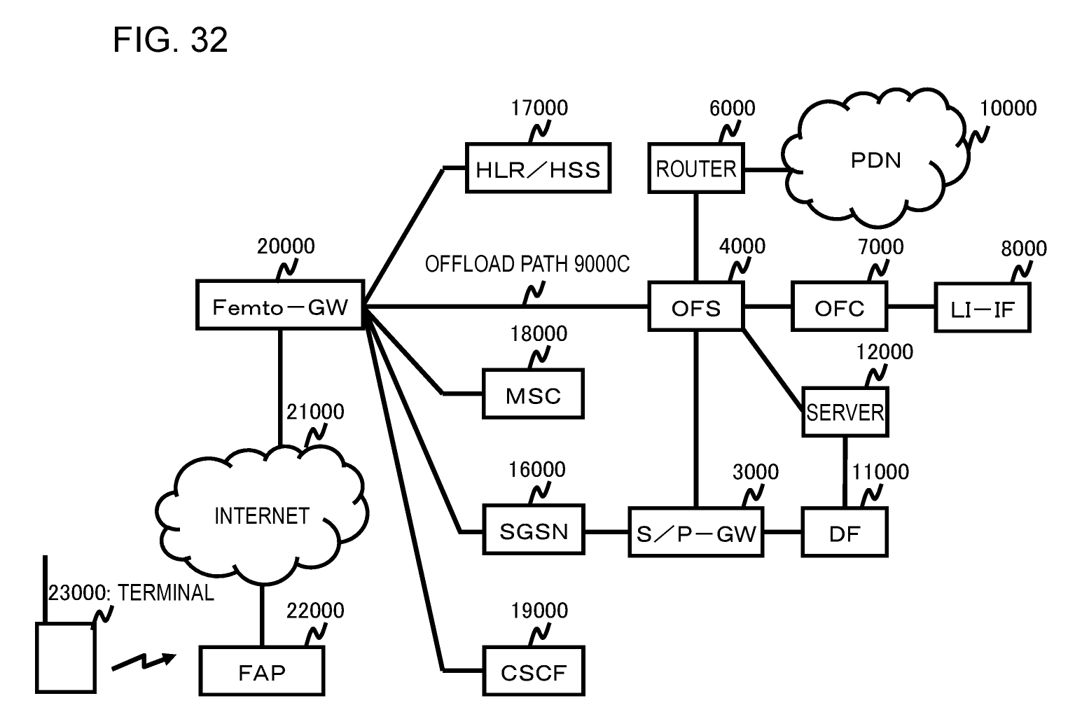

FIG. 32 illustrates a configuration example of a communication system according to an eleventh example embodiment in which the present disclosure is applied to a femtocell radio communication system. The configuration on the right side in FIG. 32 includes a router 6000, a PDN 10000, an OFS 4000, an OFC 7000, an LI-IF 8000, a server 12000, a DF 11000, and an S/P-GW 3000, which are the same as those according to the ninth example embodiment illustrated in FIG. 25.

The OFS 4000 is connected to a femto gateway (Femto-GW) 20000 that has a traffic offload (TOF) function via an offload path 9000C. The femto gateway 20000 is connected to a femtocell base station (a femtocell access point: FAP) 22000 via an Internet 21000.

In the present example embodiment, too, the OFC 7000 operates in the same way as that according to the eighth to tenth example embodiments. Namely, when the OFC 7000 receives a connection request in which offload is requested, the OFC 7000 refers to a UE information management table in a management database 7040 and determines whether an offload target terminal 23000 is using the LI function. If the offload target terminal 23000 is not using the LI function, the OFC 7000 determines that offload is possible. Next, the OFC 7000 sets a flow entry for instructing packet forwarding via the offload path 9000C in the OFS 4000 and instructs the femto gateway 2000 to apply offload. In this way, the femto gateway 20000 starts offloading. Namely, offload target packets are forwarded to the OFS 4000 via the offload path 9000C that bypasses the core network, and the packets are further forwarded to the PDN 10000 via the router 6000. In addition, target packets forwarded from the PDN 10000 to the OFS 4000 via the router 6000 are forwarded to the femto gateway 20000 via the offload path 9000C that bypasses the core network, and the packets are further forwarded to the FAP 22000 through the Internet 21000.

In contrast, if the offload target terminal 23000 is using the LI function, the above control is not performed. Instead, the communication is performed via a usual path which passes through the mobile core (a path passing through the SGSN 16000 and the S/P-GW 3000), without using offload.

Likewise, when the OFC 7000 receives an LI request from the LI-IF 8000, the OFC 7000 performs control processing based on the offload status of the LI target terminal 23000. If the communication of the LI target terminal 23000 is not offloaded, the OFC 7000 does not perform any control processing and allows the femto gateway 20000 to continue the communication via the mobile core. In contrast, if the communication of the LI target terminal 23000 is offloaded, to switch the path to the path passing through the mobile core, the OFC 7000 transmits a flow entry to the OFS 4000, instructs the femto gateway 20000 to stop offloading, and causes the femto gateway 20000 to switch the path to the path passing through the mobile core (the SGSN 16000 and the S/P-GW 3000). Next, as in the eighth example embodiment, the offload status and the LI status are registered and managed in the UE information management table in the management database 7040 in the OFC 7000.

In addition, in the configuration example in FIG. 32, the server 12000 is connected to the OFS 4000, as in the ninth example embodiment. When the server 12000 has the LI function, even when the communication of the LI target terminal 23000 is offloaded, the OFC 7000 may transmit a flow entry for instructing packet forwarding to the server 12000 to the OFS 4000 and allow the femto gateway 20000 to continue the application of offload.

As described above, according to the present disclosure, the offload of communication via the FAP 22000 and the application of a NW function(s) are both achieved.

### Twelfth Example Embodiment

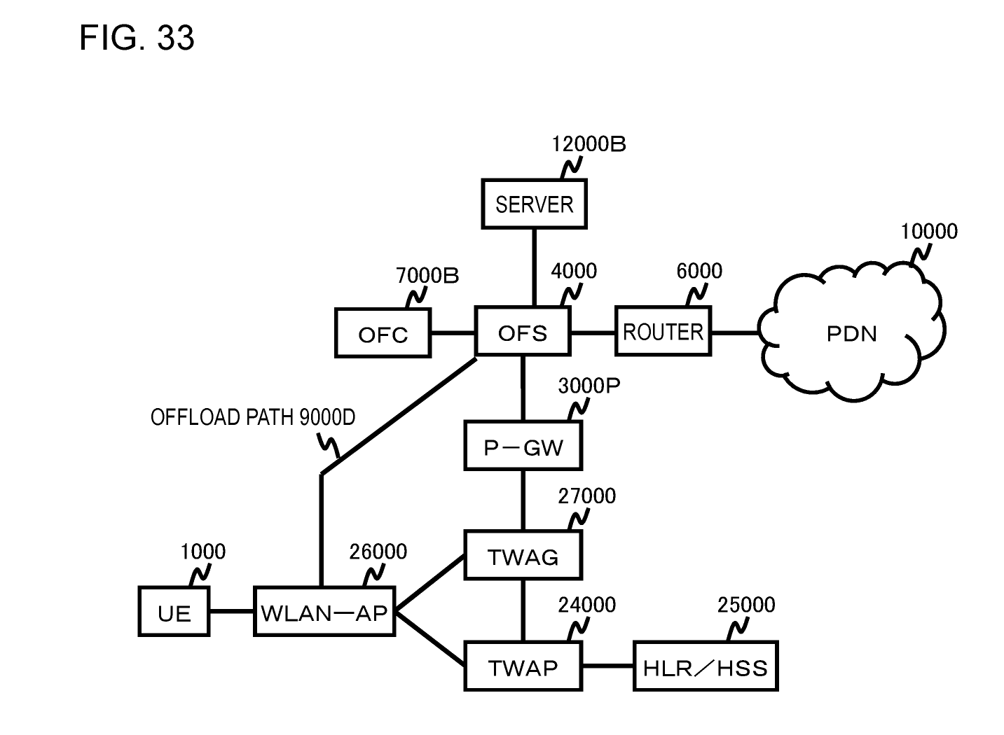

FIG. 33 illustrates a configuration example of a communication system according to a twelfth example embodiment in which the present disclosure is applied to a wireless LAN (Local Area Network) communication system. The configuration in FIG. 33 includes a server 12000B, an OFC 7000B, an OFS 4000, a router 6000, and a PDN 10000, which are the same as those according to the ninth example embodiment illustrated in FIG. 25.

The OFS 4000 is connected to a wireless LAN access point (WLAN-AP) 26000 via an offload path 9000D.

The WLAN-AP 26000 is connected to a Trusted WLAN Access Gateway (TWAG) 27000 and a Trusted WLAN AAA Proxy (TWAP) 24000. The TWAP 24000 is connected to a subscriber database (HLR (Home Location Register)/HSS) 25000.

In the present example embodiment, too, the OFC 7000B operates in the same way as that according to the ninth example embodiment. Namely, when the OFC 7000B receives a connection request in which offload is requested, the OFC 7000B refers to a UE information management table in a management database 7040 and determines whether a UE 1000 is using the filter function. If the offload target UE 1000 is not using the filter function, the OFC 7000B determines that offload is possible. Next, the OFC 7000B sets a flow entry for instructing packet forwarding via the offload path 9000D in the OFS 4000 and instructs the WLAN-AP 26000 to apply offload. In this way, the WLAN-AP 26000 starts offloading. Namely, offload target packets are forwarded to the OFS 4000 via the offload path 9000D that bypasses the TWAG 27000 and the TWAP 24000, and the packets are further forwarded to the PDN 10000 via the router 6000. In addition, target packets forwarded from the PDN 10000 to the OFS 4000 via the router 6000 are forwarded to the WLAN-AP 26000 via the offload path 9000D that bypasses the core network, and the packets are further forwarded to the UE 1000.

In contrast, when the offload target UE 1000 is using the filter function, the above control is not performed. Instead, communication is performed via a usual path which passes through the TWAG 27000 and the TWAP 24000, without using offload.

In addition, in the configuration example in FIG. 33, the server 12000B is connected to the OFS 4000, as in the ninth example embodiment. When the server 12000B has the filter function, even when a request for use of the filter function is made, the offload does not need to be stopped immediately. In this case, the OFC 7000B may transmit a flow entry for instructing forwarding of target packets to the server 12000B to the OFS 4000 and allow the WLAN-AP 26000 to continue the application of offload.

While example embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings.

For example, an individual unit (processing means) of the offload apparatus, the control apparatus, the server, the OFC, etc. illustrated in the above drawings can be realized by a computer program that causes a computer constituting the corresponding apparatus to execute the above corresponding processing by using its hardware.

Finally, suitable modes of the present invention will be summarized.

### [Mode 1]

(See the control apparatus according to the above first aspect)

### [Mode 2]

The control apparatus according to mode 1, further including a fourth unit configured to instruct the first unit to perform addition of a network function(s) based on the attribute(s) of the received packet.

### [Mode 3]

The control apparatus according to mode 1 or 2, wherein the fourth unit instructs the first unit to form a service chain in which a plurality of network functions are linked.

### [Mode 4]

The control apparatus according to any one of modes 1 to 3, wherein the network function(s) includes at least one of a lawful interception function, an accounting function, and a filter function.

### [Mode 5]

The control apparatus according to any one of modes 1 to 4, wherein, as the attribute(s) of the received packet, identification information about the apparatus that has transmitted the packet is used.

### [Mode 6]

(See the communication system according to the above second aspect)

### [Mode 7]

(See the network function provision apparatus according to the above third aspect)

### [Mode 8]

(See the communication method according to the above fourth aspect)

### [Mode 9]

(See the computer program according to the above fifth aspect)

### [Mode 10]

A communication apparatus, including:

a first unit configured to select, from a plurality of paths including a first path connected to a second network via a first network having a plurality of network functions and a second path bypassing the first network and connected to the second network, a forwarding path which realizes, among the plurality of network functions, a network function(s) corresponding to an attribute(s) of a received packet; and

a second unit configured to forward the received packet to the forwarding path.

### [Mode 11]

The communication apparatus according to mode 10, wherein, based on an instruction from a predetermined control apparatus, the first unit selects a forwarding path that can realize a network function(s) corresponding to the attribute(s) of the received packet.

### [Mode 12]

The communication apparatus according to mode 10 or 11, wherein, when the first unit receives a request for starting or ending use of a function(s) to be applied to the received packet, the first unit re-selects a forwarding path that can realize the corresponding function(s).

### [Mode 13]

The communication apparatus according to any one of modes 10 to 12, wherein, when the second path cannot realize a network function(s) corresponding to the attribute(s) of the received packet, the first unit selects the first path.

### [Mode 14]

The communication apparatus according to any one of modes 10 to 13,

wherein a server that provides a network function(s) of the first network is arranged in the second path, and

wherein the first unit selects a path in which a server that can provide the network function(s) corresponding to the attribute(s) of the received packet is arranged.

### [Mode 15]

The communication apparatus according to any one of modes 10 to 14, wherein the network function(s) includes at least one of a lawful interception function, an accounting function, and a filter function.

### [Mode 16]

The communication apparatus according to any one of modes 10 to 15, wherein, as the attribute(s) of the received packet, identification information about the apparatus that has transmitted the packet is used.

### [Mode 17]

A control apparatus, connected to the communication apparatus according to any one of modes 10 to 16 and including a unit configured to transmit control information for selecting the path to the first unit of the communication apparatus.

### [Mode 18]

A communication system including: the communication apparatus according to any one of modes 10 to 16; and the control apparatus according to mode 17.

### [Mode 19]

A communication method, including:

selecting, from a plurality of paths including a first path connected to a second network via a first network having a plurality of network functions and a second path bypassing the first network and connected to the second network, a forwarding path which realizes, among the plurality of network functions, a network function(s) corresponding to an attribute(s) of a received packet; and forwarding the received packet to the forwarding path.

### [Mode 20]

A program, causing a computer of a communication apparatus to perform processing for:

selecting, from a plurality of paths including a first path connected to a second network via a first network having a plurality of network functions and a second path bypassing the first network and connected to the second network, a forwarding path which realizes, among the plurality of network functions, a network function(s) corresponding to an attribute(s) of a received packet; and

forwarding the received packet to the forwarding path.

Modes 6 to 9 can be expanded in the same way as mode 1 is expanded to modes 2 to 5. Likewise, modes 17 to 20 can be expanded in the same way as mode 10 is expanded to modes 11 to 16.

The disclosure of the above PTLs and NPL is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in the claims, example embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10 terminal
20 offload apparatus
40 (first) network
50 (A) to 50 (X), 9000, 9000A to 9000D offload path
60 (second) network
70 control apparatus
80, 80A, 80B server
90 packet classification apparatus
100 forwarding apparatus
110 operation management apparatus
210, 1020 packet processing unit
220 control unit
710, 810, 1130, 7010, 12010 interface
720, 840, 7020, 7050, 7060 control unit
721 offload control unit
722 function control unit
723 path control unit
730, 910, 1010 storage unit
820 NW function unit
830 information extraction unit
841 VM control unit
842 path control unit
850-1 to 850-N virtual machine (VM)
920, 1020 packet processing unit
1000 UE
1110 offload management unit
1120 function management unit
1000, 1000-1 to 1000-2 UE
2000 base station eNB having offload function
3000 S/P-GW
3000S S-GW
3000P P-GW
4000 OFS
5000 RADIUS server
6000 router
7000, 7000A, 7000B OFC
7021, 7051, 7061 offload control unit
7022 LI control unit
7023, 7053, 7063 entry control unit
7030 LI request processing unit
7040 management database
7052 accounting function control unit
7062 filter function control unit
8000 LI-IF
9000, 9000A, 9000B, 9000C, 9000D offload path
10000 PDN
11000 Delivery Function (DF)
12000, 12000A, 12000B server
12020 LI function unit
12021 LI information addition unit
12022 LI control unit
12030 packet duplication unit
12040 accounting function unit
12041 accounting information processing unit
12042 accounting function control unit
12050 filter function unit
12051 filter processing unit
12052 filter function control unit
13000 base station
14000 RNC
15000 TOF
16000 SGSN
17000, 25000 HLR/HSS
18000 MSC
19000 CSCF
20000 Femto-GW
21000 Internet
22000 FAP
23000 terminal
24000 TWAP
26000 WLAN-AP
27000 TWAG

What is claimed is:

1. A control apparatus, comprising:
a first unit configured to provide at least one of a plurality of network functions of a first network;
a second unit configured to determine, based on an attribute(s) of a received packet, whether to forward the packet to a path in which the first unit operates or to the first network; and
a third unit configured to give an instruction about a forwarding destination of the received packet to a predetermined packet forwarding apparatus in accordance with the determination.

2. The control apparatus according to claim 1, further comprising a fourth unit configured to instruct the first unit to perform addition of a network function(s) based on the attribute(s) of the received packet.

3. The control apparatus according to claim 2, wherein the fourth unit instructs the first unit to form a service chain in which a plurality of network functions are linked.

4. The control apparatus according to claim 1, wherein the network function(s) includes at least one of a lawful interception function, an accounting function, and a filter function.

5. The control apparatus according to claim 1, wherein, as the attribute(s) of the received packet, identification information about the apparatus that has transmitted the packet is used.

6-12. (canceled)

13. A communication apparatus, comprising:
a first unit configured to select, from a plurality of paths including a first path connected to a second network via a first network having a plurality of network functions and a second path bypassing the first network and connected to the second network, a forwarding path which realizes, among the plurality of network functions, a network function(s) corresponding to an attribute(s) of a received packet; and
a second unit configured to forward the received packet to the forwarding path.

14. The communication apparatus according to claim 13, wherein, based on an instruction from a predetermined control apparatus, the first unit selects a forwarding path that can realize a network function(s) corresponding to the attribute(s) of the received packet.

15. The communication apparatus according to claim 13, wherein, when the first unit receives a request for starting or ending use of a function(s) to be applied to the received packet, the first unit re-selects a forwarding path that can realize the corresponding function(s).

16. The communication apparatus according to claim 13, wherein, when the second path cannot realize a network function(s) corresponding to the attribute(s) of the received packet, the first unit selects the first path.

17. The communication apparatus according to claim 13,
wherein a server that provides a network function(s) of the first network is arranged in the second path, and
wherein the first unit selects a path in which a server that can provide the network function(s) corresponding to the attribute(s) of the received packet is arranged.

18. The communication apparatus according to claim 13, wherein the network function(s) includes at least one of a lawful interception function, an accounting function, and a filter function.

19. The communication apparatus according to claim 13 wherein, as the attribute(s) of the received packet, identification information about the apparatus that has transmitted the packet is used.

20. A control apparatus, connected to the communication apparatus according to claim 13 and comprising a unit configured to transmit control information for selecting the path to the first unit of the communication apparatus.

21. The control apparatus according to claim 20, further comprising third unit for instructing, when a request for starting or ending use of a function(s) to be applied to the received packet is received, re-selection of a forwarding path that can realize the corresponding function(s).

22. The control apparatus according to claim 20, wherein, when the second path cannot realize a network function(s) corresponding to the attribute(s) of the received packet, the control apparatus transmits control information for selecting the first path.

23. The control apparatus according to claim 20, further comprising a second unit configured to manage a use status(es) of the network function(s) per communication, wherein the control apparatus refers to information managed by the second unit and determines whether to change a forwarding path.

24. The control apparatus according to claim 20,
wherein a server that provides the network function(s) of the first network is arranged in the second path, and
wherein the control apparatus transmits control information for selecting a path in which a server that can provide the network function(s) corresponding to the attribute(s) of the received packet is arranged.

25. The control apparatus according to claim 20, wherein the network function(s) includes at least one of a lawful interception function, an accounting function, and a filter function.

26. The control apparatus according to claim 20, wherein, as the attribute(s) of the received packet, identification information about the apparatus that has transmitted the packet is used.

27. (canceled)

28. A communication method, comprising:
determining, based on an attribute(s) of a received packet, whether to forward the packet to a path in which a first apparatus providing at least one of a plurality of network functions of a first network or to the first network; and
giving an instruction about a forwarding destination of the received packet to a predetermined packet forwarding apparatus in accordance with the determination.

29. A communication method, comprising:
selecting, from a plurality of paths including a first path connected to a second network via a first network having a plurality of network functions and a second path bypassing the first network and connected to the second network, a forwarding path which realizes, among the plurality of network functions, a network function(s) corresponding to an attribute(s) of a received packet; and
forwarding the received packet to the forwarding path.

30-31. (canceled)
